(19) United States
(12) Patent Application Publication
(10) Pub. No.: US 2015/0324507 A1
(43) Pub. Date: Nov. 12, 2015

(54) PRINTED CIRCUIT BOARD DESIGN VERIFICATION SYSTEM, PRINTED CIRCUIT BOARD DESIGN VERIFICATION METHOD, AND RECORDING MEDIUM

(71) Applicant: Tomochika TAKAMI, Tokyo (JP)

(72) Inventor: Tomochika TAKAMI, Tokyo (JP)

(73) Assignee: HITACHI, LTD., Tokyo (JP)

(21) Appl. No.: 14/411,996

(22) PCT Filed: Sep. 13, 2012
(86) PCT No.: PCT/JP2012/073502

§ 371 Date: Dec. 30, 2014

(51) Int. Cl. G06F 17/50

(52) U.S. Cl. CPC G06F 17/5045; G06F 2217/02; G06F 2217/06; G06F 2217/78

(57) ABSTRACT

[Object] A printed circuit board design verification system for reducing the entire process time required for designing of a printed circuit board.

[Solution]

A printed circuit board design verification system 1 includes: a data storage unit 120 for storing data 121 to 125 which are input by an input device 20; a design verification unit 130 for verifying a current density in a current path of a printed circuit board when manufactured; and an output device 30 for outputting verification results by the design verification unit 130. Then, the design verification unit 130 for the printed circuit board design verification system 1: acquires the data 121 to 125; searches a current path in the manufactured printed circuit board; determines a value of an electric current flowing through each copper foil plane which forms wiring of the searched current path; determines a copper foil plane current path indicative of the current path in each copper foil plane; calculates a current density in each copper foil plane; judges whether the calculated current density exceeds an allowable range of a designed value or not; and determines a wiring part of the copper foil plane, which does not satisfy a criterion for the judgment, as a rejected part.

### TECHNICAL FIELD

The present invention relates to a printed circuit board design verification system, a printed circuit board design verification method, and a recording medium and is suited for use in a printed circuit board design verification system, printed circuit board design verification method, and recording medium for verifying a current density in a current path of a printed circuit board.

### BACKGROUND ART

A printed circuit board assumes a role to physically and electrically connect semiconductor components such as an integrated circuit (IC: Integrated Circuit) or a large-scale integrated circuit (LSI: Large Scale Integration) by means of solder joints. Recently, as the accuracy of mounting compounds on a printed circuit board enhances, connecting parts between the semiconductor components and the printed circuit board become minuter. Generally, electric connections between the semiconductor components on the printed circuit board are realized via wiring, which is an electric conductor, provided on the printed circuit board. So, as the connecting parts between the semiconductor components and the printed circuit board become minuter, a wiring density in the printed circuit board increases. Also, an area reduction of the printed circuit board and a reduction of the number of layers are required in order to reduce cost. As a result, a size reduction of a power supply circuit for supplying electric power to the printed circuit board is required, which makes current paths further complicated.

The power supply circuit of the printed circuit board uses a copper foil plane as a current path and an allowable range of the density of an electric current flowing through the copper foil plane is defined in a design stage. However, during the process of designing the printed circuit board (mainly in and after a mid-course stage of designing), the size of the copper foil plane for power supply may sometimes be reduced in order to add wiring; and if the size of the copper foil plane is reduced too much, there is a possibility that the density of the electric current flowing through the copper foil plane may exceed a designed value. Particularly in recent years, a wiring density of the printed circuit board has increased and the current path has become more complicated as described above, so that the situation where the current density exceeds the designed value due to the size reduction of the copper foil plane tends to easily occur more often than before. If the printed circuit board is manufactured without noticing that the density of the electric current flowing through the copper foil plane exceeds the designed value, a manufacturer will notice the excessive density of the electric current flowing through the copper foil plane for the first time when placing components on the printed circuit board and activating a device with that printed circuit board mounted thereon. In this case, the printed circuit board will have to be redesigned and remanufactured and, therefore, rework will be required.

There is an actual measurement test of a printed circuit board as one of methods for checking whether or not there is any anomaly before operating a device with the printed circuit board mounted thereon. The actual measurement test of the printed circuit board is to check consistency between the manufactured printed circuit board and design data and, for example, Patent Literature 1 describes a printed circuit board test support device for supporting an efficient actual measurement test of the printed circuit board. The printed circuit board test support device described in Patent Literature 1 is characterized in that it narrows down a wiring pattern, which is an object of the actual measurement test, and supports the efficient actual measurement test by identifying a wiring pattern of great importance, in which problems may occur noticeably at the time of the actual measurement test, based on the degree of degradation of signal properties.

### CITATION LIST

### Patent Literature

[Patent Literature 1] Japanese Patent Application Laid-Open (Kokai) Publication No. 2011-29285

### SUMMARY OF INVENTION

### Problems to be Solved by the Invention

However, the printed circuit board test support device described in Patent Literature 1 supports the actual test of the manufactured printed circuit board. Therefore, the problem which still remains is that if any anomaly is found, the printed circuit board needs to be redesigned and remanufactured. Furthermore, the printed circuit board test support device described in Patent Literature 1 uses changes of characteristic impedance of wiring patterns and crosstalk, which occurs in the wiring patterns, as methods for identifying a wiring pattern of great importance. So, the problem is that it cannot be applied to the usage to verify changes of the current density in a current path of the copper foil plane.

The present invention was devised in consideration of the above circumstances and aims at suggesting a printed circuit board design verification system, printed circuit board design verification method, and recording medium for reducing the entire process time required for designing of a printed circuit board.

### Means for Solving the Problems

In order to solve the above-described problems, the present invention provides a printed circuit board design verification system comprising: an input unit for inputting printed circuit board design data indicative of data determined by no later than a mid-course stage or it subsequent stage of designing of a printed circuit board, and printed circuit board manufacturing data indicative of data required when manufacturing the printed circuit board; a storage unit for storing the input data; a design verification unit for calculating a current density in a current path of the printed circuit board, when manufactured, based on the data stored in the storage unit, and judging whether a rejected part of wiring in which the current density in excess of an allowable range defined as a designed value occurs exists in the current path or not, by referring to the calculated current density; and an output unit for outputting information indicative of the rejected part of the wiring; wherein the design verification unit: acquires the data stored in the data storage unit; searches the current path in the manufactured printed circuit board based on the acquired data; determines a value of an electric current flowing in each copper foil plane, which forms wiring, with respect to the searched current path; determines a copper foil plane current path indicative of the current path in each copper foil plane; calculates the current density in each copper foil plane based on the value of the electric current and the copper foil plane current path which are determined with respect to each copper foil plane; and judges whether the calculated current density exceeds an allowable range of the designed value or not, and determines a wiring part of the copper foil plane, which does not satisfy a criterion for the judgment, as the rejected part.

Furthermore, in order to solve the above-described problems, the present invention provides a printed circuit board design verification method by a printed circuit board design verification system for verifying whether or not a current density in a current path exceeds an allowable range defined as a designed value when a printed circuit board is manufactured, the printed circuit board design verification system including: an input unit for inputting data; a data storage unit for storing the data; a design verification unit for verifying, based on the data stored in the data storage unit, the current density in the current path when the printed circuit board is manufactured; and an output unit for outputting a verification result by the design verification unit; the printed circuit board design verification method comprising: a data input step executed by the input unit of inputting printed circuit board design data indicative of data determined by no later than a mid-course stage or it subsequent stage of designing of a printed circuit board, and printed circuit board manufacturing data indicative of data required when manufacturing the printed circuit board; a data storage step executed by the data storage unit of storing the input data; a data acquisition step executed by the design verification unit of acquiring the stored data; a current path search step executed by the design verification unit of searching the current path in the manufactured printed circuit board based on the acquired data; a current value determination step executed by the design verification unit of determining a value of an electric current flowing in each copper foil plane, which forms wiring of the current path, with respect to the searched current path; a copper foil plane current path determination step executed by the design verification unit of determining a copper foil plane current path indicative of the current path in each copper foil plane for which the value of the electric current has been determined; a current density calculation step executed by the design verification unit of calculating the current density in each copper foil plane based on the value of the electric current determined in the current value determination step and the copper foil plane current path determined in the copper foil plane current path determination step; a rejected part judgment step executed by the design verification unit of judging whether the calculated current density exceeds the allowable range of the designed value or not, and determining a wiring part of the copper foil plane, which does not satisfy a criterion for the judgment, as a rejected part; and a verification result output step executed by the output unit of outputting the wiring part which has been determined as the rejected part.

Furthermore, in order to solve the above-described problems, the present invention provides a computer-readable recording medium with a program recorded therein for having a computer with a storage area, into which printed circuit board design data indicative of data determined by no later than a mid-course stage or its subsequent stage of designing of the printed circuit board, and printed circuit board manufacturing data indicative of data required when manufacturing the printed circuit board are input and stored, execute the following procedures: a data acquisition procedure for acquiring the printed circuit board design data and the printed circuit board manufacturing data which are stored in the storage area; a current path search procedure for searching the current path in the manufactured printed circuit board based on the data acquired in the data acquisition procedure; a current value determination procedure for determining a value of an electric current flowing in each copper foil plane, which forms wiring of the current path, with respect to the current path searched in the current path search procedure; a copper foil plane current path determination procedure for determining a copper foil plane current path indicative of the current path in each copper foil plane for which the value of the electric current was determined in the current value determination procedure; a current density calculation procedure for calculating the current density in each copper foil plane based on the value of the electric current determined in the current value determination procedure and the copper foil plane current path determined in the copper foil plane current path determination procedure; and a rejected part judgment procedure for judging whether the current density calculated in the current density calculation procedure exceeds an allowable range of a designed value or not, and determining a wiring part of the copper foil plane, which does not satisfy a criterion for the judgment, as a rejected part.

### Advantageous Effects of Invention

According to the present invention, it is possible to realize a printed circuit board design verification system, printed circuit board design verification method, and recording medium capable of reducing the entire process time required for designing of a printed circuit board in and after a mid-course stage of designing.

### BRIEF DESCRIPTION OF DRAWINGS

FIG. 1 is a block diagram showing a configuration example of a design authentication system according to one embodiment of the present invention.

FIG. 2 is a block diagram showing a hardware configuration example of a computer shown in FIG. 1.

FIG. 3 is a table chart for explaining one example of printed circuit board design data.

FIG. 4 is a schematic diagram for explaining a pin-mounting face of a printed circuit board.

FIG. 5 is a table chart (1) showing an example of an input current value table indicating input current values.

FIG. 6 is a table chart (2) showing an example of the input current value table indicating input current values.

FIG. 7 is a table chart showing an example of a GND wiring name table indicative of GND wiring names.

FIG. 8 is a table chart showing an example of a component current value table which defines component current values.

FIG. 9 is a table chart showing an example of a wiring current value table which defines wiring current values.

FIG. 10 is a flowchart showing an example of a processing sequence for determining a starting point of a current path.

FIG. 11 is a table chart showing an example of a starting point component table.

FIG. 12 is a schematic diagram of a printed circuit board, which is a verification object, as seen from above.

FIG. 13 is a flowchart showing an example of a processing sequence for searching and determining a path from the starting point of the current path to its end point.

FIG. 14 is a flowchart showing the details of a processing sequence for searching the current path in the processing sequence shown in FIG. 13.

FIG. 15 is a schematic diagram of a printed circuit board as seen from above after mounting components.

FIG. 16 is a table chart showing an example of a current path table.

FIG. 17 is a conceptual diagram showing the current path, which is indicated by the current path table in FIG. 16, in a tree structure.

FIG. 18 is a flowchart showing an example of a processing sequence for determining a value of the electric current value flowing in the current path.

FIG. 19 is a table chart showing an example of a current path table to which a current value of a steady-state current is added.

FIG. 20 is a conceptual diagram of the current path, which is indicated by the current path table in FIG. 19, in a tree structure.

FIG. 21 is a table chart showing an example of a current path table to which a current value of an abnormal current is added.

FIG. 22 is a conceptual diagram of the current path, which is indicated by the current path table in FIG. 21, in a tree structure.

FIG. 23 is an explanatory diagram (1) showing an example of a copper foil plane.

FIG. 24 is an explanatory diagram (2) showing an example of the copper foil plane.

FIG. 25 is an explanatory diagram for explaining a method for determining a current path in the copper foil plane shown in FIG. 24.

FIG. 26 is an explanatory diagram (3) showing an example of the copper foil plane.

FIG. 27 is an explanatory diagram (4) showing an example of the copper foil plane.

FIG. 28 is an explanatory diagram (5) showing an example of the copper foil plane.

FIG. 29 is a sectional view of an example of the printed circuit board.

FIG. 30 is a conceptual diagram of part of the printed circuit board shown in FIG. 29 as seen from above.

FIG. 31 is a conceptual diagram of the printed circuit board shown in FIG. 29 as seen from below.

FIG. 32 is an explanatory diagram for explaining a method for calculating a minimum value of a current path width.

FIG. 33 is a flowchart showing an example of a processing sequence for calculating the minimum value of the current path width.

FIG. 34 is an explanatory diagram (6) showing an example of the copper foil plane.

FIG. 35 is a schematic diagram for explaining a current density.

FIG. 36 is a data diagram showing an example of a calculation result list and a reference value list.

FIG. 37 is a data diagram showing an example of a rejected part list.

### MODE FOR CARRYING OUT THE INVENTION

### (1) One Embodiment of the Present Invention

A design authentication system according to one embodiment of the present invention is characterized in that the design authentication system calculates a current density in a current path of a printed circuit board, when manufactured, based on data determined by no later than a mid-course stage or it subsequent stage of designing of the printed circuit board and data required when manufacturing the printed circuit board, and verifies, based on the calculated current density, whether or not there is any rejected part of wiring where the current density in the current path exceeds an allowable range defined as a designed value.

### (1-1) Overall Configuration of Printed Circuit Board Design Verification System

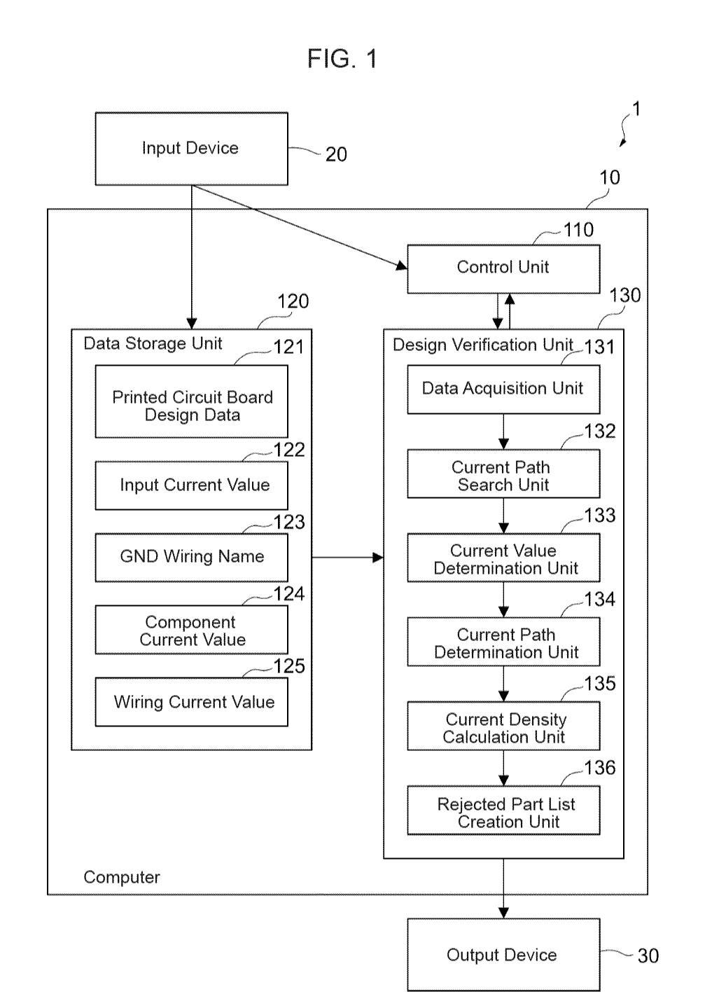

FIG. 1 is a block diagram showing a configuration example of a design authentication system according to one embodiment of the present invention. Referring to FIG. 1, a printed circuit board design verification system 1 is configured by including a computer 10, an input device 20, and an output device 30. The computer 10 is connected to the input device 20 and the output device 30 and is realized by an information processing unit such as a personal computer or a server. The input device 20 is, for example, a mouse or a keyboard and has a function inputting signals to the computer 10 according to a user's input operation. The output device 30 is, for example, a display or a printer and has a function outputting processing results by the computer 10.

Incidentally, the following explanation will be given on the premise that a copper foil plane is an aggregate of line segments and arcs, a pin on which a component is mounted is rectangular, a via is circular, and unit systems for coordinates are millimeters; however, the present invention is not limited to such premise.

### (1-2) Configuration of Computer

The computer 10 shown in FIG. 1 will be explained below. The computer 10 includes: a control unit 110 for controlling each part of the computer 10, a data storage unit 120 for storing data input from the input device 20, and a design verification unit 130 for verifying a current density in a current path of a printed circuit board. The data storage unit 120 stores data about the printed circuit board, which is required for verification by the design verification unit 130; and the design verification unit 130 verifies a current density in a current path of the printed circuit board by referring to the data stored in the data storage unit 120 under the control of the control unit 110.

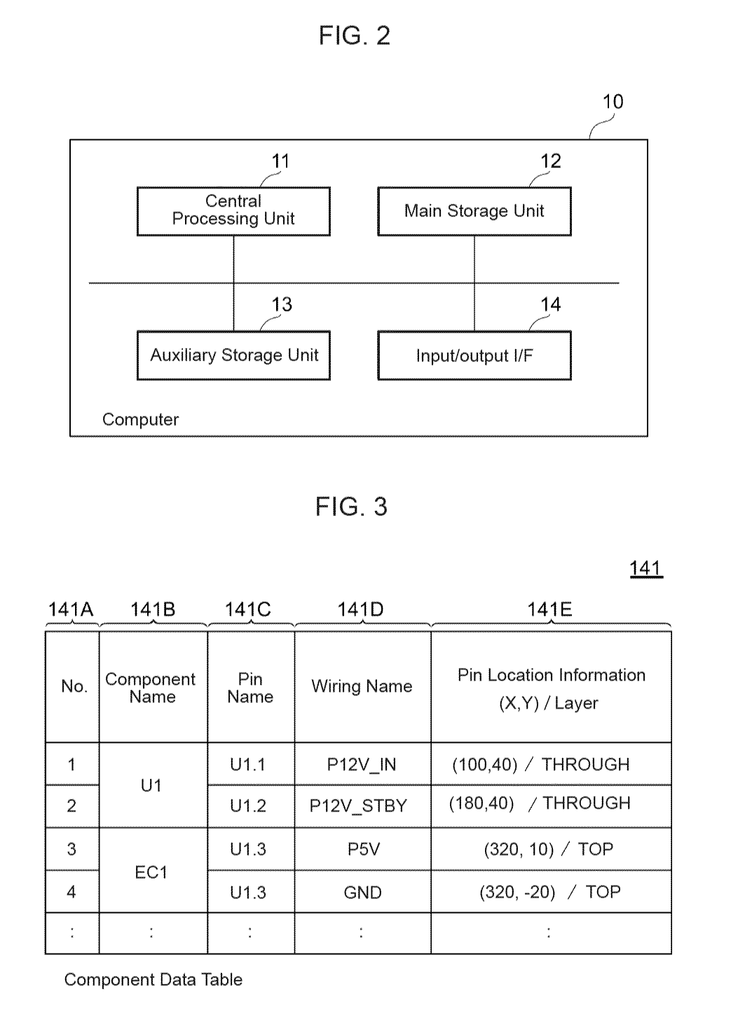

Now, FIG. 2 is a block diagram showing a hardware configuration example of the computer shown in FIG. 1. The computer 10 shown in FIG. 2 is a computer configured in such a manner that a central processing unit (CPU) 11, a main storage unit 12, an auxiliary storage unit 13, and an input/output interface (I/F) 14 are connected to each other via a bus. The control unit 110 in FIG. 1 corresponds to the central processing unit 11 in FIG. 2 and the data storage unit 120 in FIG. 1 has a storage area to store the data and corresponds to at least either the main storage unit 12 or the auxiliary storage unit 13 shown in FIG. 2. The main storage unit 12 and the auxiliary storage unit 13 are computer-readable recording media with programs recorded therein. The design verification unit 130 in FIG. 1 is implemented by the central processing unit 11 as it invokes and executes the programs stored in at least either the main storage unit 12 or the auxiliary storage unit 13. The input/output interface 14 is an interface for externally inputting and outputting data to and from the computer 10 and connects to the input device 20 and the output device 30.

### (1-3) Data Storage Unit

As shown in FIG. 1, the data storage unit 120 stores printed circuit board design data 121, an input current value 122, a ground (GND) wiring name 123, a component current value 124, and a wiring current value 125 as the data about the printed circuit board, which is required for verification by the design verification unit 130. The printed circuit board design data 121 is data determined when designing the printed circuit board which is a verification object; and the input current value 122, the GND wiring name 123, the component current value 124, and the wiring current value 125 are examples of printed circuit board manufacturing data which is required when manufacturing the printed circuit board.

With the printed circuit board design verification system 1 shown in FIG. 1, the printed circuit board design data 121 and the printed circuit board manufacturing data are input from the input device 20 to the data storage unit 120 in advance before the verification of the current density by the design verification unit 130. Each piece of data of the printed circuit board design data 121 and the printed circuit board manufacturing data is managed, for example, in a table format as explained below. It should be noted that unless specifically stated about each table, an explanation about columns with the same item name will be omitted below by assuming that the same description will applied to the columns with the same item name as its description which will be given first time when that item name appears in the following explanation.

### (1-3-1) Printed Circuit Board Design Data

The printed circuit board design data 121 includes descriptions of, for example, names and location information about each of components, component pins (which are also called pins), copper foil planes, and wiring that are used or formed on a printed circuit board which becomes a verification object. As the printed circuit board design data 121, design data after the completion of designing may be used or design data in and after a mid-course step of designing may be used if copper foil plane information which makes it possible to identify a current path in the printed circuit board can be provided in that step.

FIG. 3 is a table chart for explaining an example of the printed circuit board design data. A component data table 141 show in FIG. 3 indicates part of the printed circuit board design data 121 and its each row describes information about components. FIG. 3 is configured as a table having: a number column 141A in which a reference number is described; a component name column 141B in which a component name is described; a pin name column 1410 in which the name of a pin mounted on the relevant component is described; a wiring name column 1410 in which the name of wiring connected by the relevant pin is described; and a pin location information column 141E in which location information indicative of the location of the relevant pin is described. FIG. 3 indicates X-Y coordinates of the relevant pin and a layer in which the pin is located in the printed circuit board are described as the location information described in the pin location information column 141E.

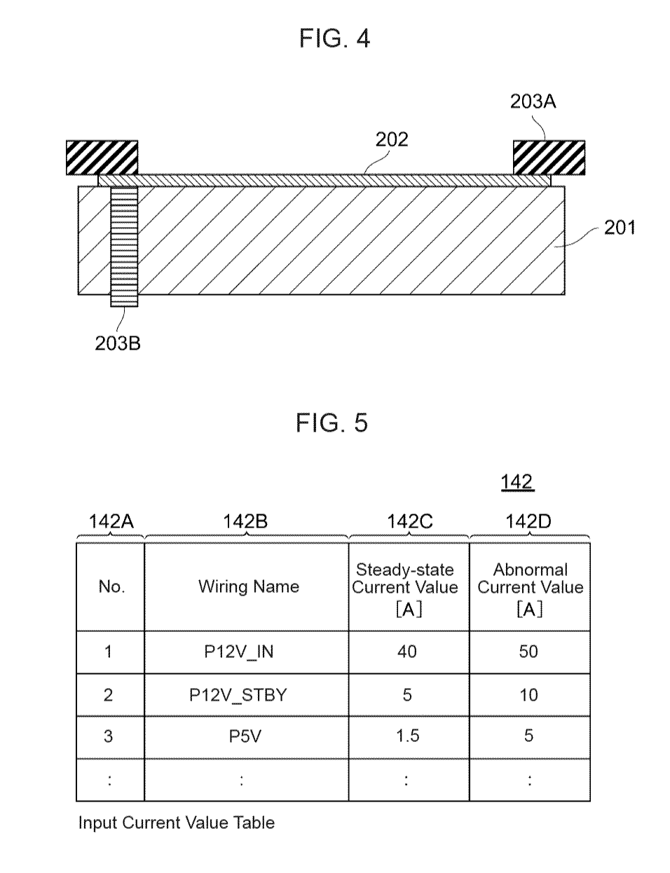

FIG. 4 is a schematic diagram for explaining a pin-mounted face of the printed circuit board. Referring to FIG. 4, with respect to one layer with a printed circuit board, a wiring layer 202 is provided on an upper surface of an insulating layer 201 and a pin 203A is further provided on an upper surface of the wiring layer 202. Furthermore, a pin 203B is provided below the wiring layer 202 so that it pierces through the insulating substrate 201. Under this circumstance, the pin location information column 141E describes the pin 203A as “TOP” and the pin 203B as “THROUGH.”

Therefore, for example, a row of FIG. 3 where the number column 141A indicates “1” shows that a pin called “U1.1” is provided on a component called “U1” and wiring whose wiring name is “P12V_IN” is connected to that pin. Furthermore, it is shown that the pin “U1.1” is provided by piercing through the insulating substrate (“THROUGH”) at a position of the X-Y coordinates (100, 40).

Incidentally, the printed circuit board design data 121 is an example of the printed circuit board design data indicative of the data determined by no later than a mid-course stage or it subsequent stage of designing of the printed circuit board; however, the component data table 141 which is actually constituted from the printed circuit board design data 121 can also be considered as the data determined by no later than the mid-course stage or its subsequent stage of designing of the printed circuit board.

### (1-3-2) Input Current Value and GND Wiring Name

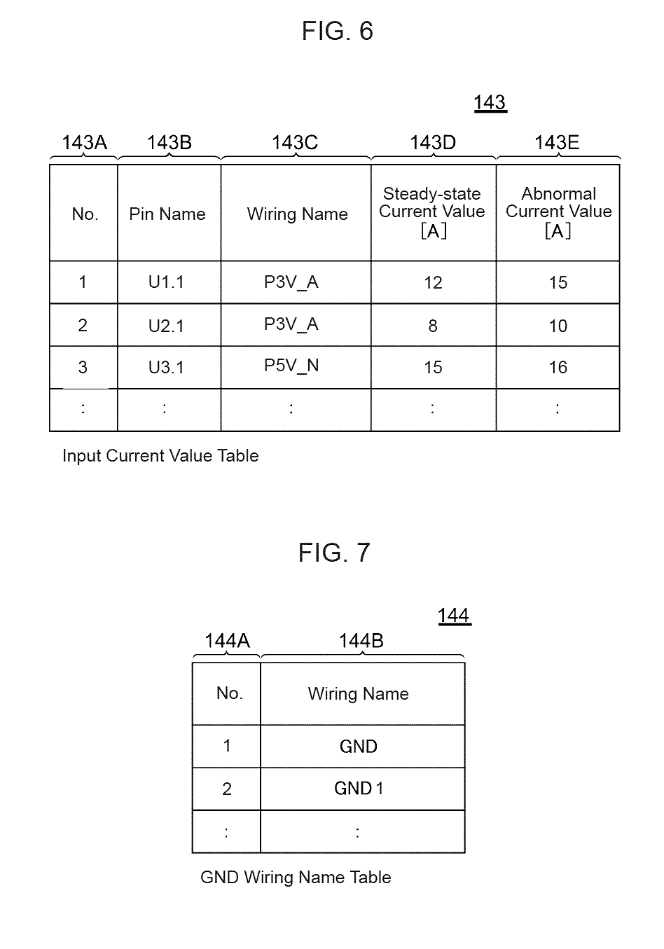

The input current value 122 is a value of an electric current supplied to wiring of the printed circuit board. FIG. 5 and FIG. 6 are table charts which show examples of an input current value table indicative of input current values. An input current value table 142 in FIG. 5 is constituted from a number column 142A in which the reference number is described, a wiring name column 142B, a steady-state current value column 142C, and an abnormal current value column 142D. The wiring name column 142B describes a wiring name of the printed circuit board to which the electric current is supplied.

The steady-state current value column 142C describes a maximum electric current value in a state of normal operation (steady-state current value) when the relevant printed circuit board is manufactured and thereafter applied to a device. The steady-state current value is a value used to verify whether or not any inconveniency would be caused to the normal operation of the device due to a high current density in the state where the device with the relevant printed circuit board mounted thereon is in normal operation.

The abnormal current value column 142D describes a value of the electric current (abnormal current value), regarding which it is guaranteed that the electric current in excess of this value will not flow because of, for example, a fuse or a protection circuit of an electric current supply source when the relevant printed circuit board is manufactured and thereafter applied to the device. The abnormal current value is a value used to verify whether or not the device will be protected or burned out when an abnormal current occurs. Since the steady-state current value and the abnormal current value in the following explanation will have the same definitions as described above, an explanation about them will be omitted.

An input current value table 143 in FIG. 6 is constituted from: a number column 143A; a pin name column 143B where the name of a pin to which the electric current is supplied is described; a wiring name column 143C; a steady-state current value column 143D in which a steady-state current value is described; and an abnormal current value column 143E in which an abnormal current value is described. The input current value table 143 is configured so that the pin name column 143B in which the pin name is described is added to the input current value table 142 in FIG. 5. Since the input current value table 143 in FIG. 6 can set the input current value corresponding to the relevant pin, it is possible to designate the input current value which is minuter than an input current value corresponding to the wiring as shown in the input current value table 142 in FIG. 5. Furthermore, because the pin name is described in the pin name column 143B, the wiring name corresponding to the relevant pin can be acquired by referring to FIG. 3. So, the input current value table 143 does not have to have the wiring name column 143C.

Incidentally, with the printed circuit board design verification system 1 according to this embodiment, the input current value 122 may only have to be stored in the data storage unit 120 in the format of at least either the input current value table 142 or the input current value table 143.

The GND wiring name 123 is information about GND wiring formed in the printed circuit board. FIG. 7 is a table chart showing an example of a GND wiring name table which indicates GND wiring names. A GND wiring name table 144 in FIG. 7 is constituted from a number column 144A in which the reference number is described, and a wiring name 144B in which a wiring name of the relevant GND wiring is described.

### (1-3-3) Component Current Value

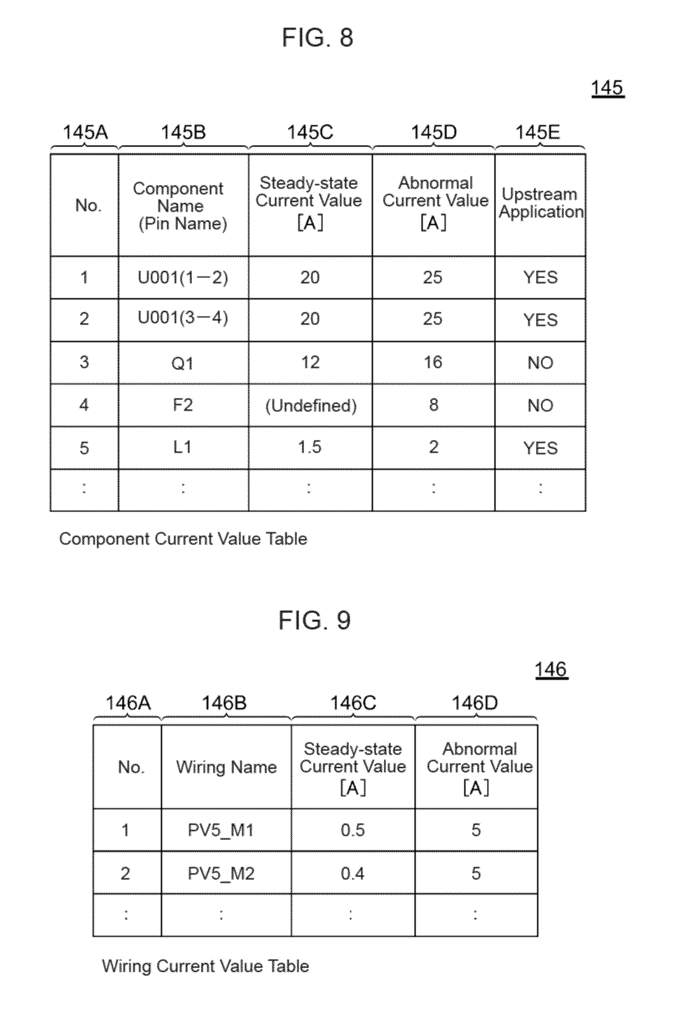

The component current value 124 indicates a value of the electric current which flows on the downstream side of a component. FIG. 8 is a table chart showing an example of a component current value table which defines the component current value. A component current value table 145 in FIG. 8 is constituted from a number column 145A, a component name column 145B in which the name of a component defining the component current value is described, a steady-state current value column 145C, an abnormal current value column 145D, and an upstream application column 145E. Incidentally, as seen in a row where “1” or “2” is indicated in the number column 145A, the component name column 145B may describe not only the component name, but also the pin name of pins provided on the relevant component. The steady-state current value column 145C and the abnormal current value column 145D describe the steady-state current value and the abnormal current value about a component which is described in the component name column 145B of the same row. Furthermore, the upstream application column 145E indicates “YES” when it is defined that the electric current of the same volume of the electric current flows on the upstream side of the relevant component as its downstream side (upstream application can be performed); and the upstream application column 145E otherwise indicates “NO.”

The component current value table 145 in FIG. 8 shows an example in which in a case of a plurality of inductors aggregating in one component, such component is treated in the same manner as a component having one inductor by defining pins of the inductors. For example, regarding a row where the number column 145A in FIG. 8 indicates “1,” pin “1” and pin “2” whose component name is “U001” are treated as one inductor; and regarding a row where the number column 145A indicates “2,” pin “3” and pin “4” whose component name is “U001” are treated as one inductor. Furthermore, a row where the number column 145A indicates “3” defines a component current value which flows through a transistor with three pins indicated by a component name “Q1.”

Furthermore, a row in which the number column 145A in FIG. 8 indicates “4” defines a component current value which flows through a fuse indicated by a component name “F2.” Generally, when the electric current in excess of a rated value flows, the fuse blocks such electric current. So, the steady-state current value is not defined and only the abnormal current value is defined. Furthermore, a row in which the number column 145A indicates “5” defines a component current value which flows through an inductor indicated by a component name “L1.”

Under this circumstance, in a case where a component through which the electric current flows is a 2-pin component, the electric current of the same volume flows at both upstream and downstream of the component. So, it is possible to apply the same value of the electric current as downstream wiring to upstream wiring which directly connects to the component. In this case, “YES” is defined in the upstream application column 145E. Accordingly, for example, regarding the row in which “1” or “2” is indicated in the number column 145A, the component “U001” is defined as a component having two pins in each row and, therefore, the upstream application is defined as “YES.”

On the other hand, a transistor “Q1” for which “3” is indicated in the number column 145A is a 3-pin (multiple-pin) component as described above and the current value is not generally the same at downstream and upstream, so that the upstream application is “NO.” Furthermore, a fuse “F2” for which “4” is indicated in the number column 145A is a 2-pin component; however, since the value of the electric current which flows at its upstream may sometimes exceeds a rated value of the fuse because of properties of the fuse, the upstream application is defined as “NO.”

### (1-3-4) Wiring Current Value

The wiring current value 125 is a value of the electric current which flows at wiring parts. FIG. 9 is a table chart showing an example of a wiring current value table which defines the wiring current value. A wiring current value table 146 shown in FIG. 9 is constituted from a number column 146A, a wiring name column 146B, a steady-state current value column 146C, and an abnormal current value column 146D. While the component current value table 145 shown in FIG. 8 defines values of the electric current with respect to the components, the wiring current value table 146 shown in FIG. 9 directly defines values of the electric current with respect to wiring.

Furthermore, if wiring whose electric current values can be determined in both the component current value table 145 and the wiring current value table 146 exists, the current value which is determined in either of these tables may be used. In this embodiment, the electric current value determined based on the wiring current value table 146 is used and prioritized over the electric current value determined based on the component current value table 145.

Incidentally, the input current value 122, the GND wiring name 123, the component current value 124, and the wiring current value 125 which have been described above are examples of the printed circuit board manufacturing data indicative of data required when manufacturing a printed circuit board, but we can say that the input current value tables 142 and 143, the GND wiring name table 144, the component current value table 145, and the wiring current value table 146 which actually constitute each data are also examples of the printed circuit board manufacturing data.

### (1-4) Design Verification Unit

As shown in FIG. 1, the design verification unit 130 has a data acquisition unit 131, a current path search unit 132, a current value determination unit 133, a current path determination unit 134, a current density calculation unit 135, and a rejected part list creation unit 136. The design verification unit 130 is implemented as mentioned earlier by executing programs under the control of the control unit 110 and verifies a current density in a current path of a manufactured printed circuit board. Verification of the current density in the current path of the printed circuit board by the design verification unit 130 is started as triggered by input of a specified execution command from the input device 20 to the control unit 110 to start the verification of the current density and issuance of an instruction from the control unit 110, which has received the execution command, to the design verification unit 130 to execute verification processing.

Regarding the verification of the current density by the design verification unit 130, the data acquisition unit 131 firstly acquires necessary data for the verification from the data storage unit 120 and the current path search unit 132 searches a current path in the manufactured printed circuit board based on information about copper foil planes and wiring of the printed circuit board. Next, the current value determination unit 133 determines a value of the electric current flowing each copper foil plane, which forms wiring of the current path, based on the current path searched by the current path search unit 132 and the input current value 122, the component current value 124, and the wiring current value 125 acquired by the data acquisition unit 131. Next, the current path determination unit 134 determines a current path in each copper foil plane which forms wiring (copper foil plane current path), based on information about the copper foil plane and the current path searched by the current path search unit 132. Then, the current density calculation unit 135 calculates the current density in the copper foil plane current path determined by the current path determination unit 134. Lastly, the rejected part list creation unit 136 judges whether the current density calculated by the current density calculation unit 135 is within an allowable range that satisfies a designed value or not; and the rejected part list creation unit 136 creates and outputs a list of parts determined to be rejected (rejected parts). Such current density verification processing by the design verification unit 130 will be explained below in more detail.

### (1-4-1) Data Acquisition

When the design verification unit 130 firstly receives the instruction from the control unit 110 to execute the current density verification processing, the data acquisition unit 131 accesses the data storage unit 120 and acquires various data 121 to 125 which are stored in the data storage unit 120. Incidentally, the data which are actually acquired by the data acquisition unit 131 from the data storage unit 120 are: the component data table 141, regarding which FIG. 3 shows an example; the input current value tables 142 and 143, regarding which FIG. 5 and FIG. 6 show examples; the GND wiring name table 144, regarding which FIG. 7 shows an example; the component current value table 145, regarding which FIG. 8 shows an example; and the wiring current value table 146, regarding which FIG. 9 shows an example.

Then, the data acquisition unit 131 extracts information related to components, component pins, copper foil planes, and wiring (component information, pin information, copper foil plane information, and wiring information) from the printed circuit board design data 121 (or the component data table 141). Subsequently, the data acquisition unit 131 notifies the current path search unit 132 of the completion of acquisition of the data.

### (1-4-2) Current Path Search

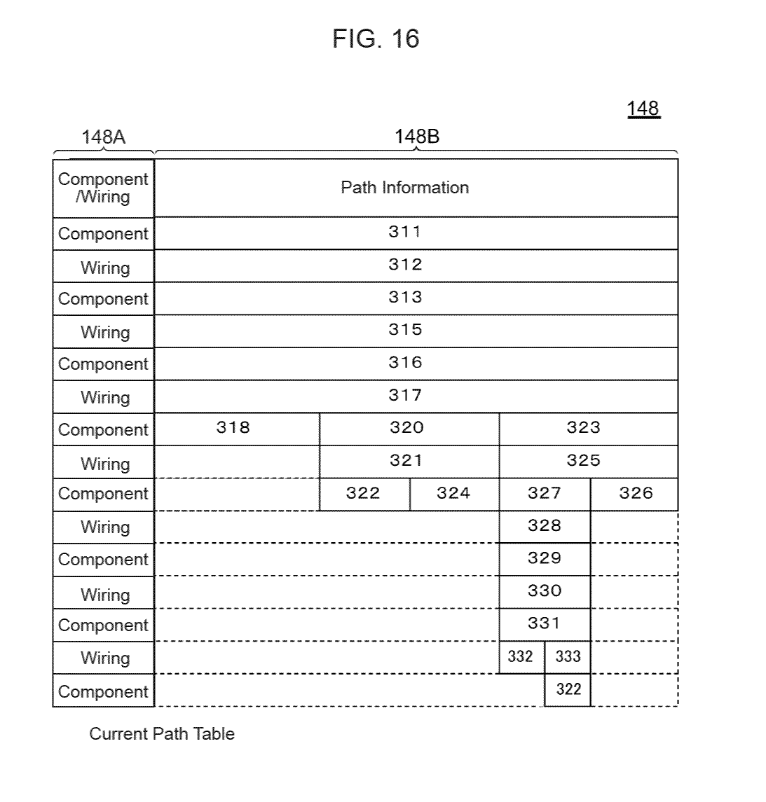

After receiving the notice of the completion of data acquisition by the data acquisition unit 131, the current path search unit 132 searches the current path in the manufactured printed circuit board based on the information acquired by the data acquisition unit 131 and creates a table for showing the current path (a current path table). The current path table will be explained later with reference to FIG. 16.

### (1-4-2-1) Determination of Starting Point of Current Path

The current path search unit 132 firstly determines a component to which the electric current is input, that is, a starting point of the current path by referring to the input current value table in order to create the current path table.

Now, a case where the input current value table 142 shown in FIG. 5 is used as the input current value table will be explained. The input current value table 142 is a table which describes a value of the electric current flowing with respect to each wiring. So, if the electric current value is to be designated based on the input current value table 142, it is necessary to identify which component among a plurality of components connected to the wiring is the component to which the electric current is input. Generally, it is presumed that a supply source of the electric current is a connector component, which should be a component with a large number of pins. Accordingly, the current path search unit 132 searches for a component with the maximum number of pins from among a plurality of components connected to the relevant wiring with respect to each wiring whose name is described in the wiring name column 142B of the input current value table 142, and determines that the component with the maximum number of pins as the electric current supply source. The data acquisition unit 131 can acquire the number of pins on the plurality of components connected to the wiring by referring to the component information and the pin information which are extracted from the printed circuit board design data 121 (or the component data table 141).

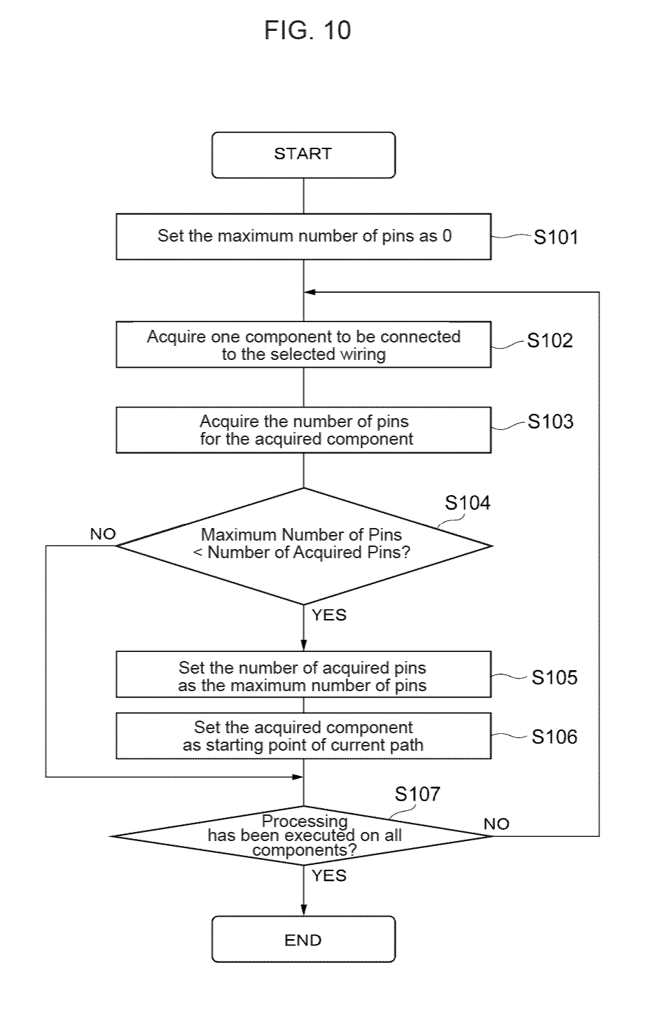

FIG. 10 is a flowchart illustrating an example of a processing sequence for determining the starting point of the current path. A method for determining the starting point of the current path by using the input current value table 142, in which an electric current value of each wiring is described, will be explained with reference to FIG. 10.

Firstly, in step S101 of FIG. 10, the current path search unit 132 initializes the maximum number of pins by setting it as “0.” The “Maximum Number of Pins” is a variable and the set value is saved. Next, the current path search unit 132 selects one wiring described in the input current value table 142, refers to the component information extracted from the component data table 141, and acquires one component to be connected to the relevant wiring (step S102). Then, the current path search unit 132 refers to the pin information extracted from the component data table 141 and acquires the number of pins on the component acquired in step S102 (step S103).

Next, the current path search unit 132 judges whether or not the value of the “Maximum Number of Pins” is less than the number of pins acquired in step S103 (step S104). If the value of the “Maximum Number of Pins” is less than the number of pins acquired in step S103 (YES in step S104), the current path search unit 132 sets the number of pins acquired in step S103 as the “Maximum Number of Pins” (step S105). Furthermore, the current path search unit 132 sets the component acquired in step 3102 as the starting point of the current path (step S106). The “Starting Point of Current Path” is also a variable like the “Maximum Number of Pins” and the set value is saved.

If the value of the “Maximum Number of Pins” is equal to or more than the number of pins acquired in step S103 (NO in step S104) or after the processing in step 3106, the processing proceeds to step 3107 and the current path search unit 132 judges whether or not the processing from step S102 to step S104 has been executed on all components of the selected wiring (whether the processing has been executed or not). If there is any component on which the processing has not been executed (NO in step S107), the current path search unit 132 executes the processing in step S102 and subsequent steps again on another component of the relevant wiring.

If it is determined in step S107 that the processing has been executed on all the components (YES in step S107), the component which is then set as the “Starting Point of Current Path” becomes a component which is the starting point of the current path for the relevant wiring. Then, the current path search unit 132 can determine a component which becomes a starting point of a current path for each wiring by executing the processing of steps 3101 to 3107 described above on all of the wiring described in the input current value table 142.

Meanwhile, if the input current value table 143 shown in FIG. 6 is used as the input current value table, a value of the electric current flowing is indicated for each pin in the input current value table 143, so that the current path search unit 132 does not have to execute the processing as shown in FIG. 10 and can determine the starting point of the current path by referring to the input current value table 143.

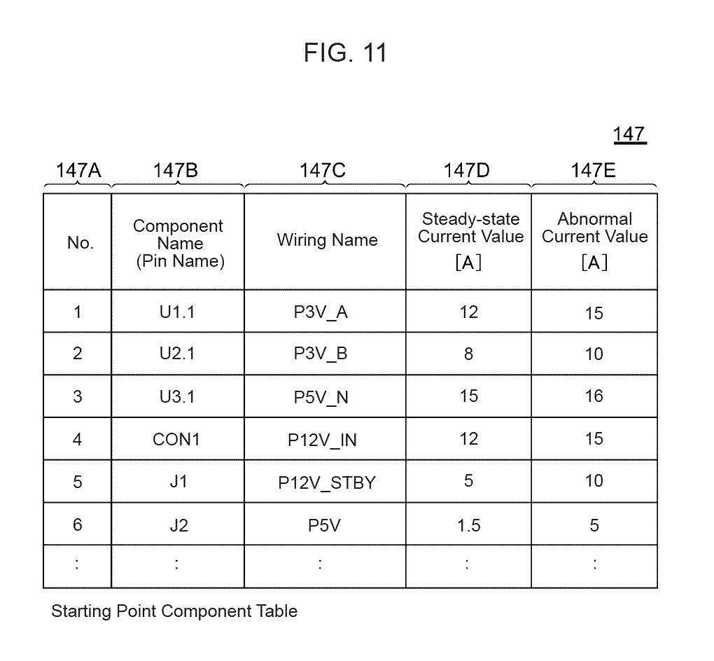

The current path search unit 132 can determine the starting point component, which becomes the starting point of the current path, based on the input current value table 142 or the input current value table 143 as described above; and then, a new table (starting point component table) may be created in order to maintain information indicative of this determined starting point component. A starting point component table will be stored in, for example, the main storage unit 12. FIG. 11 is a table chart showing an example of the starting point component table. The starting point component table 147 is constituted from a number column 147A, a component name column 147B, a wiring name column 147C, a steady-state current value column 147D, and an abnormal current value column 147E, and indicates both a starting point component (or pin) and an input current value together, with respect to the relevant wiring.

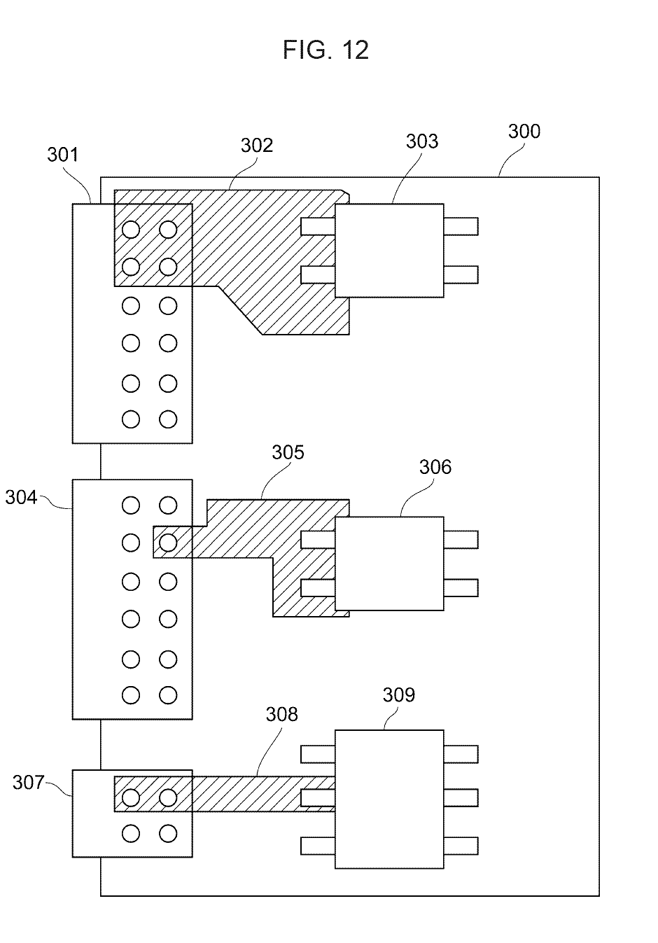

Next, a starting point of a power path will be explained by using a model of a printed circuit board. FIG. 12 is a schematic diagram of a printed circuit board which is a verification object as seen from above. Components 301, 303, 304, 306, 307, 309 represent components provided on an upper surface of a substrate 300; and particularly, the components 301, 304, 307 are connector components and power supply sources. Wiring 302, 305, 308 represents wiring provided on an upper surface of the printed circuit board 300. The wiring 302 connects the component 301 and the component 303, the wiring 305 connects the component 304 and the component 306, and the wiring 308 connects the component 307 and the component 309. In this example, it is assumed that the wiring 302, 305, 308 corresponds to wiring names “P12V_IN,” “P12V_STBY,” and “P5V” shown as examples in FIG. 5 in the order listed above.

A circle or a protrusion at each component 301, 303, 304, 306, 307, 309 in FIG. 12 represents a pin. For example, the number of pins for the component 301 is 12 and the number of pins for the component 303 is four. Regarding each wiring 302, 305, 308, a component with the maximum number of pins among connected components will be determined as a starting point of the current path as explained earlier. For example, regarding the wiring 302, its connected components are the component 301 and the component 303 and the number of pins for such components is 12 and four, so that regarding the wiring 302, the component 301 is determined as the starting point of the current path. Similarly, regarding the wiring 305, the component 304 is determined as the starting point of the current path; and regarding the wiring 308, the component 309 is determined as the starting point of the current path.

Incidentally, a component with the maximum number of pins is judged based on the total number of pins for the relevant component without limitation to the number of pins connected to the wiring. For example, regarding the component 306 connected to the wiring 305, the number of pins in its connecting part is two, which is more than the number of pins (one) in a connecting part of the component 304 similarly connected to the wiring 305; however, the component 304 is determined as the starting point of the current path based on the total number of pins.

Furthermore, in consideration of the fact that the component 307 is a connector component, an actual starting point of the current path for the wiring 308 is not the component 309, but should be the component 307; and in a case like this, the component 307 may be determined as the starting point of the current path by using the input current value table, like the input current value table 143 in FIG. 6, which clearly indicates the electric current supply source for the relevant wiring.

(1-4-2-2) Search Path from Starting Point of Current Path to its End Point

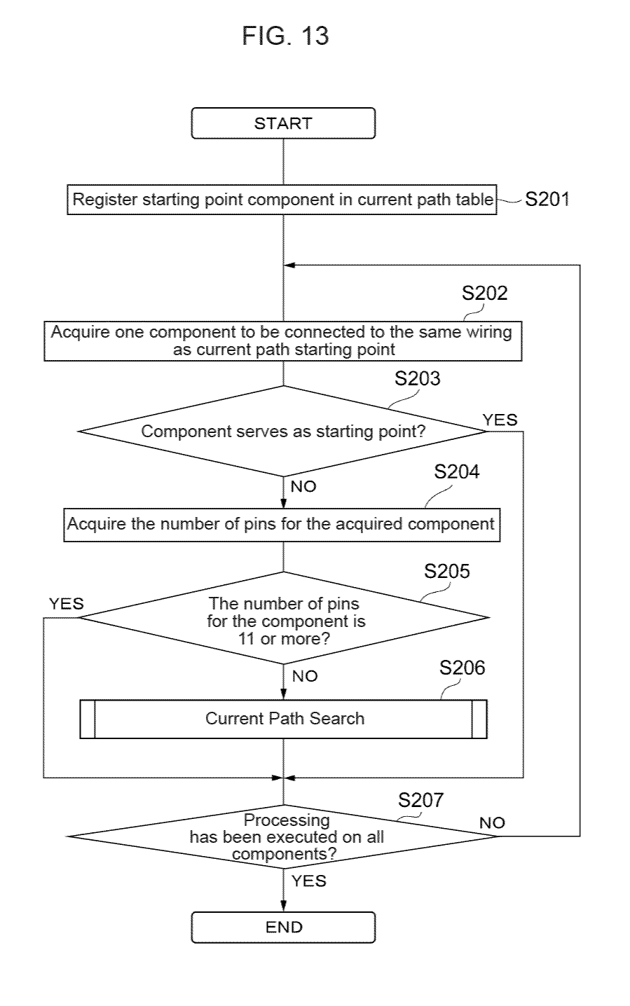

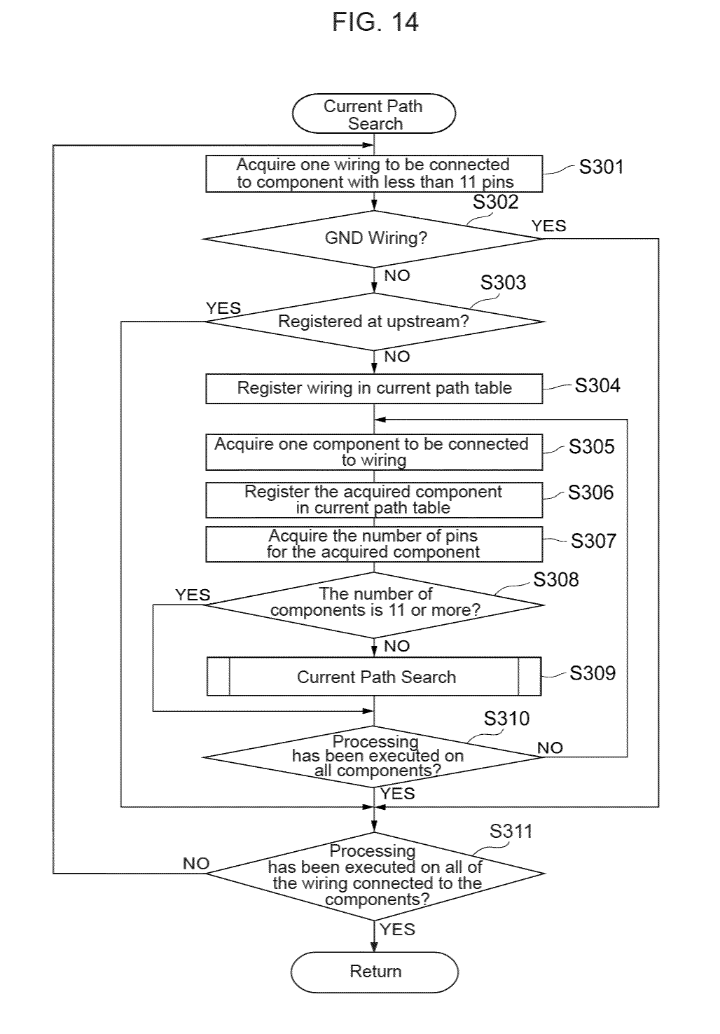

FIG. 13 is a flowchart illustrating an example of a processing sequence for searching and determining a path from a starting point of a current path to its end point. FIG. 14 is a flowchart illustrating the details of the processing sequence for searching the current path as part of the processing sequence shown in FIG. 13.

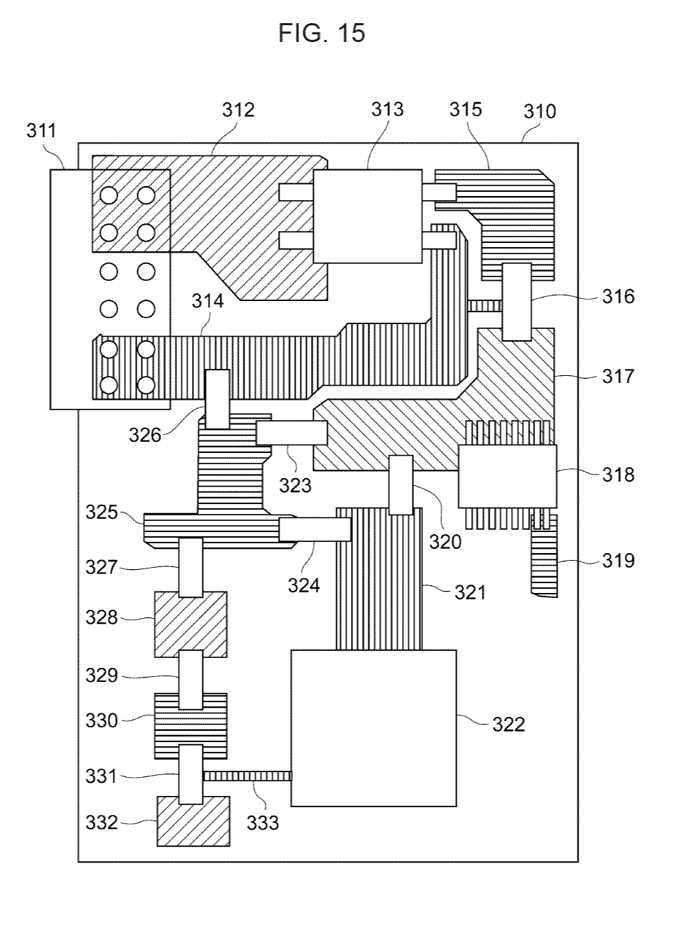

FIG. 15 is a schematic diagram of a printed circuit board as seen from above after components are mounted. The configuration of the printed circuit board as shown in FIG. 15 can be recognized even before the manufacture of a printed circuit board 310 by referring to the printed circuit board design data 121. FIG. 15 shows the components as plain areas and wiring as shaded areas. Specifically speaking components 311, 313, 316, 318, 320, 322, 323, 324, 326, 327, 329, 331 are mounted and wiring 312, 314, 315, 317, 319, 321, 325, 328, 330, 332, 333 is provided on a printed circuit board 310. The component 311 is a 12-pin connector component and is determined as a starting point of a current path by the aforementioned method for determining the starting point of the current path. Pins on each component are represented by circles or protrusions in the same manner as in FIG. 12. For example, the component 313 is a 4-pin component and the component 318 is a 16-pin component. Then, a component in a rectangular shape like the component 316 or the component 320 is a 2-pin component. Incidentally, the component 322 is an LSI and descriptions of pins are omitted. Furthermore, the wiring 314 is GND wiring.

The processing of FIG. 13 and FIG. 14 will be explained below and reference may be made to FIG. 15 in order to clarify the explanation. Incidentally, the processing of a case where the component 311 is a starting point component and there is one current path starting point will be explained below; however, when the input current value table 142 or the input current value table 143 describes a plurality of components or pins, the same processing may be executed on each of the components (or pins).

Firstly, in step S201 of FIG. 13, the current path search unit 132 registers a component which becomes a starting point of a current path (starting point component) in a current path table. FIG. 16 is a table chart showing an example of the current path table. The current path table is retained in, for example, the main storage unit 12. The current path table 148 shown in FIG. 16 is constituted from a component/wiring column 148A which describes components and wiring alternately, and a path information column 148B which describes the name of a component or wiring constituting a path. The current path table 148 in FIG. 16 shows that components and wiring indicated in upper rows of the path information column 148B are located upstream of the current path. The component name or the wiring name is registered in the current path table 148 in FIG. 16 at specified timing in accordance with the processing shown in FIG. 13 and FIG. 14. For example, since a starting point component is registered in the current path table 148 in step S201, the component name of the starting point component is described in a first row of the path information column 148B. Then, the wiring name of wiring associated when determining the starting point component is described in the next row of the path information column 148B. In order to simplify the explanation, describing the name of a component or wiring in the path information column 148B will be expressed below as registering the component or the wiring in the current path table 148.

Next, the current path search unit 132 acquires another component to be connected to the same wiring as that for the component which was determined as the starting point component in step S201 (step S202). The component connected to the same wiring can be acquired by referring to, for example, the starting point component table 147. Then, the current path search unit 132 judges whether the component acquired in step S202 is the starting point component or not (step S203). Whether it is the starting point component or not can be judged by checking, for example, whether the relevant component is described in the starting point component table 147 or not. If the component acquired in step S202 is the starting point component (YES in step S203), the processing proceeds to step S208 described later. If the component acquired in step S202 is not the starting point component (NO in step S203), the current path search unit 132 registers that component in the current path table 148 and acquires the number of pins for that component by referring to the component data table 141 (step S204).

Subsequently, the current path search unit 132 judges whether the number of pins acquired in step S204 is equal to or more than a predetermined reference number or not, in order to judge whether the component acquired in step S202 is a component with heavy power consumption or not (step S205). The component with heavy power consumption is, for example, an IC, LSI, or memory; and since a large amount of electric power is consumed by that component, it can be determined by the processing for searching the current path in order to verify an excessive current density that such component does not have to be used any longer. The reference number is the number of pins, which is a reference for presuming whether the component is an IC or LSI or not. For example, the number of pins in FIG. 13 is 11. Generally, an IC often has 14 pins or more and an LSI often has 80 pins or more.

Incidentally, if there are data collected about components with heavy power consumption, processing for judging whether the component acquired in step S202 is registered in the data collected about components with heavy power consumption or not may be executed instead of the processing from step S204 to S205.

If the number of pins is equal to or more than the reference number in step S205 (YES in step S205), it can be presumed that the relevant component is a component with heavy power consumption. So, the current path search unit 132 proceeds to processing in step S207 without searching a current path. If the number of pins is less than the reference number in step S205 (NO in step S205), the current path search unit 132 searches a current path including the component acquired in step S202 (step S206). The detailed processing of step 3206 is illustrated in FIG. 14. When the search of the current path in step S206 is completed, the processing proceeds to step S207.

In step 3207, the current path search unit 132 checks whether the execution of the processing from step S202 to step S206 on all the components connected to the same wiring as that of the starting point component has been completed or not. If there is any component which is connected to the same wiring as that of the starting point component and on which the execution of the processing from step S202 to 3206 has not been completed (NO in step S207), the current path search unit 132 returns to step S202, acquires one unprocessed component, and repeats the processing. When the execution of the processing on all the components connected to the same wiring as that of the starting point component is completed (YES in step S207), the processing is terminated.

Next, the current path search in step 3206 of FIG. 13 will be explained with reference to FIG. 14. The current path search unit 132 firstly acquires one wiring to be connected to the component acquired in step 3202 in FIG. 13, that is, one component connected to the same wiring as that of the starting point component (step S301). Incidentally, candidates for the wiring to be acquired in step 3301 do not include the wiring to which reference is made in step S202 in FIG. 13.

Then, the current path search unit 132 judges whether the wiring acquired in step 3301 is GND wiring or not (step S302). Whether the wiring is GND wiring or not can be judged by referring to the GND wiring name table 144 which describes the wiring name of GND wiring. If the relevant wiring is GND wiring (YES in step S302), the processing proceeds to step 311 described later. If the wiring acquired in step S301 is not GND wiring (NO in step S302), the current path search unit 132 judges whether the relevant wiring has been registered upstream of the current path table 148 or not (step S303). A state in which the relevant wiring has been registered upstream of the current path table 148 corresponds to, for example, a state in which the relevant wiring is already registered in a row located in the table upper than a row in which information has been registered immediately before in the current path table 148. If the relevant wiring is already registered upstream of the current path table 148 (YES in step S303), the processing proceeds to step 3311 described later. If the relevant wiring has not been registered upstream of the current path table 148 (NO in step S303), the current path search unit 132 registers the wiring acquired in step S301, as downstream wiring of the component acquired in step 3202 of FIG. 13, in the current path table 148 (step 3304).

Subsequently, the current path search unit 132 acquires one component which has not been acquired, from among components connected to the wiring registered in step S304 (step S305), and registers it in the current path table 148 (step S306), and acquires the number of pins for that component by referring to the component data table 141 (step S307). Then, the current path search unit 132 judges whether the number of pins acquired in step S307 is equal to or more than the reference number or not, in order to judge whether the component acquired in step S305 is a component with heavy power consumption or not (step S308). Since the processing of step S308 is the same as the processing of step S205 in FIG. 13, any detailed explanation about it has been omitted. The reference number in step S308 is also set as “11.”

If the number of pins is equal to or more than the reference number in step S308 (YES in step S308), the current path search unit 132 proceeds to processing of step S310 without searching a current path with respect to the component acquired in step S305 and any subsequent components. If the number of pins is less than the reference number in step S308 (NO in step S308), the current path search unit 132 searches the current path shown in FIG. 14 recursively (step S309); and after finishing searching the current path, the processing proceeds to step S310.

In step S310, the current path search unit 132 checks if the execution of the processing from S305 to S309 on all components connected to the wiring registered in the current path table 148 in step S304 has been completed or not; and if there is any component on which the execution of the processing has not been completed (NO in step S310), the processing returns to step S305 and the current path search unit 132 acquires one unprocessed component and repeats the processing. If the execution of the processing on all the components connected to the wiring registered in the current path table 148 in step S304 has been completed (YES in step S310), the processing proceeds to step S311.

In step 3311, the current path search unit 132 checks if the execution of the processing from step S301 to step S310 on all of the wiring connected to the component acquired in step 3202 of FIG. 13 or step S305 of FIG. 14 has been completed or not; and if there is any wiring on which the execution of the processing has not been completed (NO in step S311), the processing retunes to step S301 and the current path search unit 132 acquires one unprocessed wiring and repeats the processing. If the execution of the processing on all of the wiring connected to the component acquired in step 3202 of FIG. 13 or step S305 of FIG. 14 has been completed (YES in step S311), the current path search unit 132 recognizes that the search of the current path including the component acquired in step 3202 of FIG. 13 (corresponding to the processing of step S206 in FIG. 13) has been completed, and then proceeds to the processing of step 3207 in FIG. 13.

Incidentally, if there is no wiring connected to the component in step S301 of FIG. 14, or if there is no component connected to the wiring in step S305, the current path search unit 132 terminates the processing illustrated in FIG. 14 and proceeds to the processing of step 3207 in FIG. 13.

The current path search unit 132 creates the current path table 148 by executing the processing from step S201 to step S207 in FIG. 13 and from step 3301 to step S311 in FIG. 14 as described earlier.

Now, specific processing will be explained when the processing illustrated in FIG. 13 and FIG. 14 is applied to FIG. 15. Firstly, in step S201 of FIG. 13, the wiring 312 is selected and a starting point component for the wiring 312 is the component 311, so that a “component” is described in the component/wiring column 148A and the component “311” is described in the path information column 148B in a first row of the current path table 148. Then, in step 3202, the component 313 is acquired as another component connected to the same wiring 312 as the component 311. Since the component 313 is not a starting point component and the number of pins is four, which is less than the reference number, that is, 11, the processing from step 3203 to 3205 and then step S206 is executed.

Referring to FIG. 14, as the processing of step S206 on the component 313 continues, firstly in step 3301, the wiring 314, 315 exist as candidates for the same wiring as that of the component 313. If the wiring 314 is acquired here, a judgment result for step S302 is YES because the wiring 314 is GND wiring; and then the processing proceeds to step S311 and returns to S301 again. Then, if the wiring 315 is acquired, the wiring 315 is not GND wiring and has not been registered upstream and, therefore, is registered in the current path table 148 in step 3304.

In step S305, there is only one candidate for a component to be connected to the wiring 315, the component 316 is acquired and registered in the current path table 148. Since the component 316 is a 2-pin component and the number of pins is less than the reference number in step S308, the current path search is performed in step S309. Then, the wiring 314, 317 exists as candidates for wiring to be connected to the component 316 in step S301. However, because the wiring 314 is GND wiring as mentioned above, it is excluded from candidates for a current path and then the wiring 317 is acquired. Then, the wiring 317 is registered in the current path table 148 in step 3304.

Next, in step S305, the components 318, 320, 323 exist as candidates for a component to be connected to the wiring 317. If the component 318 is acquired, the number of pins for the component 318 is more than the reference number, that is, 11 and, therefore, the component 318 is just registered in the current path table 148 and the path search is not performed any further than the component 318. If the component 320 is acquired, the component 320 is registered and the processing further continues; however, finally, when and after the component 322 is registered in the current path table 148, any further path search is not performed because the component 322 is an LSI and is determined as a component with heavy power consumption. Furthermore, a path is then searched in the order of the wiring 321 the component 324, and the wiring 325 as another path after the component 320; and since the wiring 325 is already registered upstream with respect to a path from the component 323, it is not registered in the current path table 148 and any further path search is not performed.

If the component 323 is acquired as a candidate for a component to be connected to the wiring 317 in step S305, the path is search in the order illustrated in FIG. 16 although the details of the search are omitted. Now, processing executed after registration of the component 331 in the current path table 148 will be explained below. After the component 331 is registered, a current path search after the component 331 is performed in step S309. Then in step S301, the wiring 333, 332 exist as candidates for wiring. If the wiring 333 is acquired in step S301, the component 322 is searched as the path; however, since the component 322 is an LSI as mentioned earlier, any further path search is not performed. If the wiring 332 is acquired in step S301, the wiring 332 is neither GND wiring nor wiring which is already registered upstream and, therefore, is registered in the current path table 148 in step S304. Subsequently, there is no more component to be connected to the wiring 332 on the downstream side in step S305, so that the current path search unit 132 terminates the processing in FIG. 14 (step S206 in FIG. 13) and then proceeds to step S207 in FIG. 13. Then, in step S207, the execution of the processing from step S202 to step S206 on all the components connected to the wiring 312 as that of the component 311 which is set as the starting point component, so that all of the processing terminates. Incidentally, the wiring 314 is also connected to the component 311, but it is GND wiring as mentioned earlier and, therefore, any further path search is not performed. In this way, the current path table 148 shown in FIG. 16 is created.

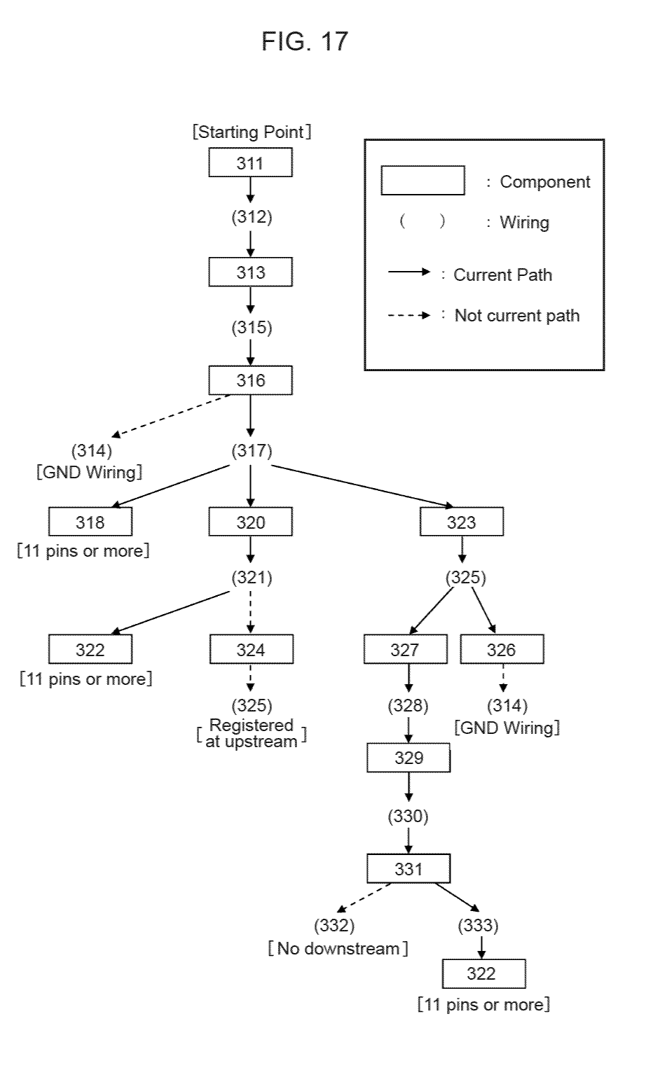

FIG. 17 is a conceptual diagram showing a current path, which is indicated by the current path table in FIG. 16, in a tree structure. As the current path search unit 132 creates the current path table 148, a current path is searched from upstream to downstream by setting the component 311 as the starting point component as shown in FIG. 17.

### (1-4-3) Determination of Electric Current Value

The current value determination unit 133 determines a value of the electric current flowing through each of copper foil planes which form wiring parts of the current path indicated by the current path table 148, based on the data acquired by the data acquisition unit 131 and the current path table 148 created by the current path search unit 132.

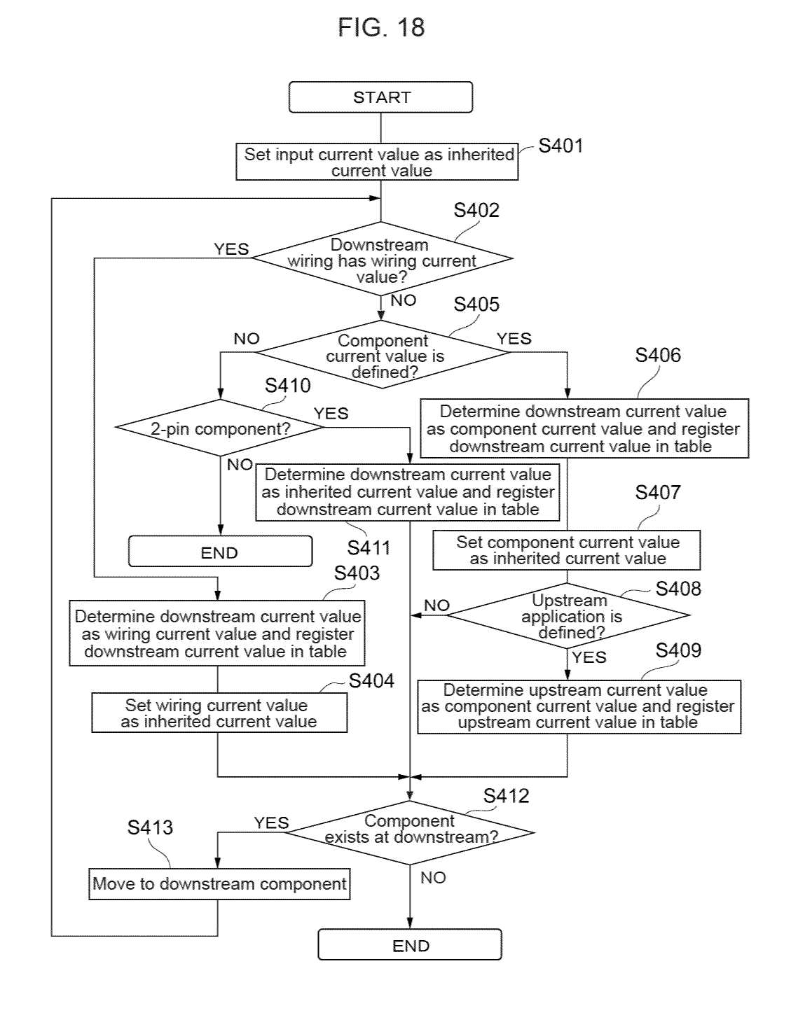

FIG. 18 is a flowchart illustrating an example of a processing sequence for determining the value of the electric current flowing through the current path. Referring to FIG. 18, a starting point component and an input current value which is input to that starting point component are given as input information. The starting point component is acquired with reference to the current path table 148 in FIG. 16 and the input current value of the starting point component is acquired with reference to at least any one of the input current value table 142 in FIG. 5, the input current value table 143 in FIG. 6, or the starting point component table 147 in FIG. 11. Incidentally, if a plurality of starting point components exist, the processing illustrated in FIG. 18 may be executed as many times as the number of the starting point components. If an electric current value is to be determined by setting somewhere in the middle of the current path table 148 as a starting point, a component which is to serve as the starting point is set as a starting point component and an input current value corresponding to that starting point component is input. When this happens, the component current value 124 of that component or the wiring current value 125 of wiring connected downstream of that component is adopted as the input current value corresponding to the starting point component.

In step S401 of FIG. 18, the current value determination unit 133 sets an input current value which is given first, as an inherited current value. The inherited current value is a variable used to determine a value of the electric current flowing downstream of a designated component (corresponding to the starting point component for the processing executed for the first time and a component selected in step S413 described later during other processing) (downstream current value).

Next, the current value determination unit 133 acquires the wiring connected downstream of the designated component and checks whether the wiring current value 125 is defined for the acquired wiring or not (step S402). For example, since the starting point component is designated for the first time processing, the current value determination unit 133 checks whether the wiring current value 125 is defined for the wiring connected downstream of the starting point component or not. The wiring connected downstream of the designated component can be acquired by referring to the current path table 148 and whether the wiring current value 125 is defined for the wiring or not can be determined by referring to the wiring current value table 146 shown in FIG. 9. Therefore, the wiring current value 125 actually corresponds to an electric current value described in the steady-state current value column 146C or the abnormal current value column 146D of the wiring current value table 146; however, it will be referred to as the wiring current value 125 in order to simplify the explanation. Also, the same applies to the component current value 124 described later and the component current value 124 actually corresponds to an electric current value described in the steady-state current value column 145C or the abnormal current value column 145D of the component current value table 145.

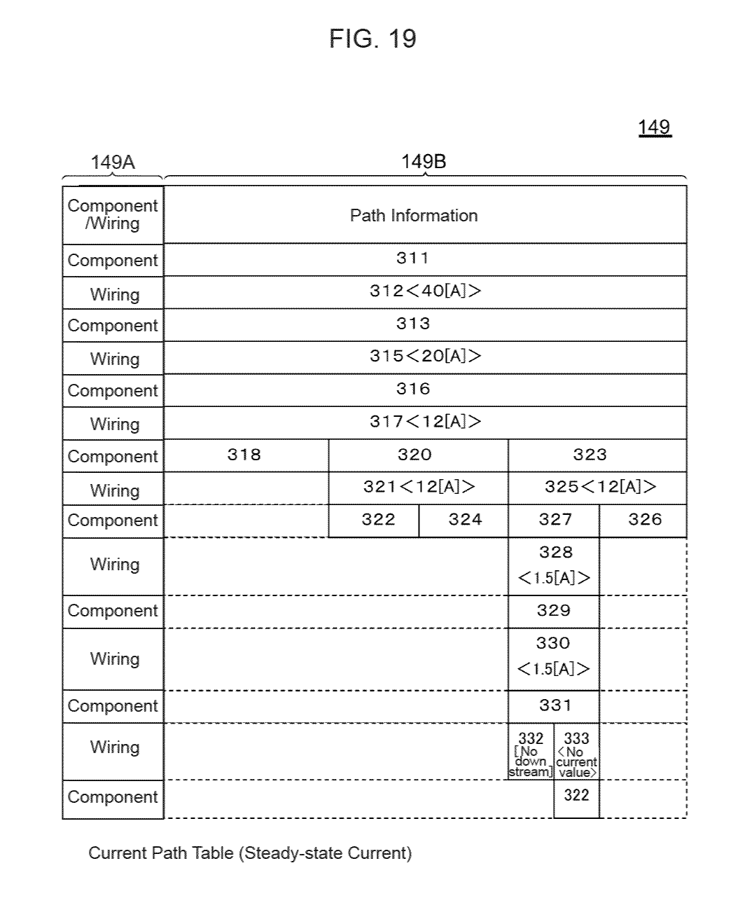

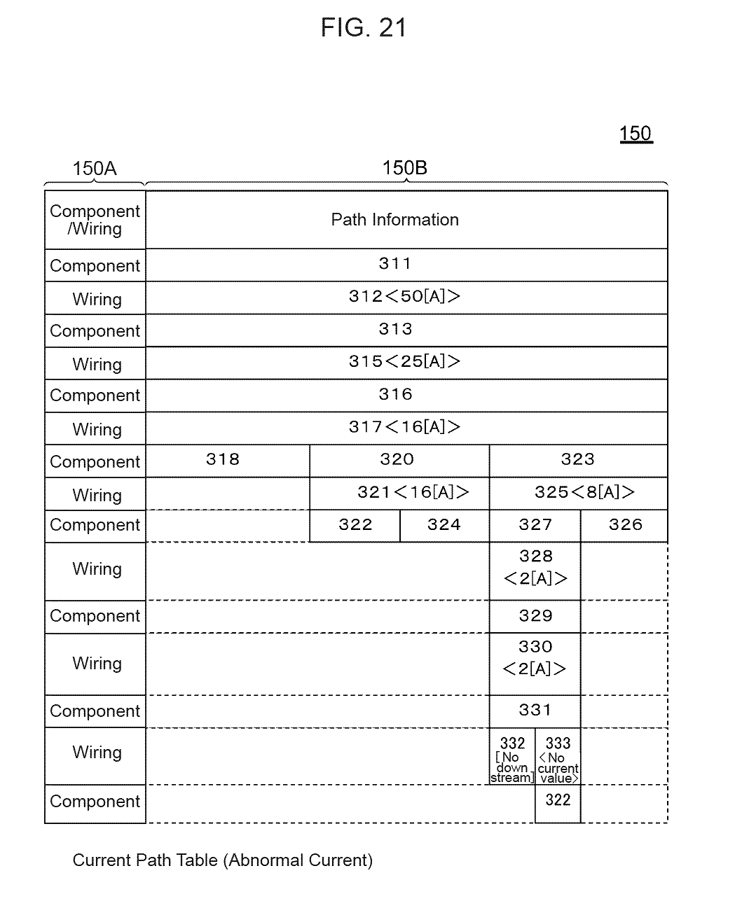

If the wiring current value 125 is defined as the downstream wiring in step S402 (YES in step S402), the current value determination unit 133 determines the wiring current value 125 as a downstream current value and registers the downstream current value in the current path table 148 created by the current path search unit 132 (step S403). When this happens, the wiring current value 125 which is determined as the downstream current value is additionally described in the column of the current path table 148, in which the downstream wiring is described. The current path table to which the electric current value is additionally described will be explained later with reference to FIG. 19 and FIG. 21. Then, the current value determination unit 133 sets the wiring current value 125 registered in step S403 as the inherited current value (step S404) and proceeds to processing in step S412 described later.

If the wiring current value 125 is not defined as the downstream wiring in step S402 (NO in step S402), the current value determination unit 133 checks if the component current value 124 is defined for the designated component or not (step S405). Whether the component current value 124 is defined for the designated component or not can be determined by referring to the component current value table 145 shown in FIG. 8.

If the component current value 124 is defined for the designated component (YES in step S405), the current value determination unit 133 determines the component current value 124 as the downstream current value and registers the downstream current value in the current path table 148 (step S406) Then, the current value determination unit 133 sets the component current value 124, which was registered in step S406, as the inherited current value (step S407) and checks whether the upstream application is defined for the designated component or not (step S408). Whether the upstream application is defined or not can be determined by referring to the upstream application column 145E of the component current value table 145. If the upstream application is not defined (NO in step S408), the processing proceeds to step S412.

If the upstream application is defined in step S408 (YES in step S408), the current value determination unit 133 determines the component current value 124 as an upstream current value and registers the upstream current value in the current path table 148 (step S409). The upstream current value is a value of the electric current which flows upstream of the designated component; and if the upstream application is defined, the upstream current value becomes the same value as the downstream current value. Subsequently, the current value determination unit 133 executes processing in step S412.

On the other hand, if the component current value 124 is not defined for the designated component in step S405 (NO in step S405), the current value determination unit 133 judges whether the designated component is a 2-pin component or not (step S410). The number of pins for the designated component can be acquired by referring to, for example, the pin information extracted from the component data table 141. Under this circumstance, it is determined that the 2-pin component is a component through which the same electric current flows downstream as that of upstream. In some case, the upstream current value may be different from the downstream current value with respect to a component such as a capacitor; and in this case, the component current value of that component may be defined as 0 in advance.

If the designated component is not a 2-pin component in step S410 (NO in step S410), there is no means for judging the downstream current value and any further current path following the downstream side of the designated component cannot be specified. Therefore, the current value determination unit 133 terminates the processing for determining the electric current value. If the designated component is a 2-pin component (YES in step 3410), the designated component has neither the downstream wiring current value 125 nor the component current value 124, but it is a 2-pin component and, therefore, it can be determined that the downstream current is the same as the upstream current. So, the current value determination unit 133 determines the downstream current value as the inherited current value and registers the downstream current value in the current path table 148 (step 3411). Subsequently, the processing proceeds to step S412.

In step 3412, the current value determination unit 133 judges whether there is a component on the downstream side of the designated component or not. Whether there is a component on the downstream side of the designated component or not can be judged by checking whether or not another component is described with respect to a path linked from the designated component to the downstream side by referring to the current path table 148. If there is no component on the downstream side of the designated component (NO in step S412), the current value determination unit 133 determines that the currently designated component is a component located furthest downstream of the current path and terminates the processing. If there is a component on the downstream side of the designated component (YES in step S412), the current value determination unit 133 selects the downstream component as the designated component (step S413) and returns to the processing in step S402.

By executing the processing from step S401 to step S413 described above, the current value determination unit 133 determines the value of the electric current flowing through each copper foil plane, which forms wiring of the relevant current path, with respect to the current path indicated by the current path table 148 and adds the determined electric current value to the current path table 148. Incidentally, if the input current value which is firstly input is an input current value which is a steady-state current value, the current value determination unit 133 determines the electric current value of the steady-state current flowing through the copper foil plane; and if an input current value which is an abnormal current value is input, the current value determination unit 133 determines the electric current value of the abnormal current flowing through the copper foil plane.

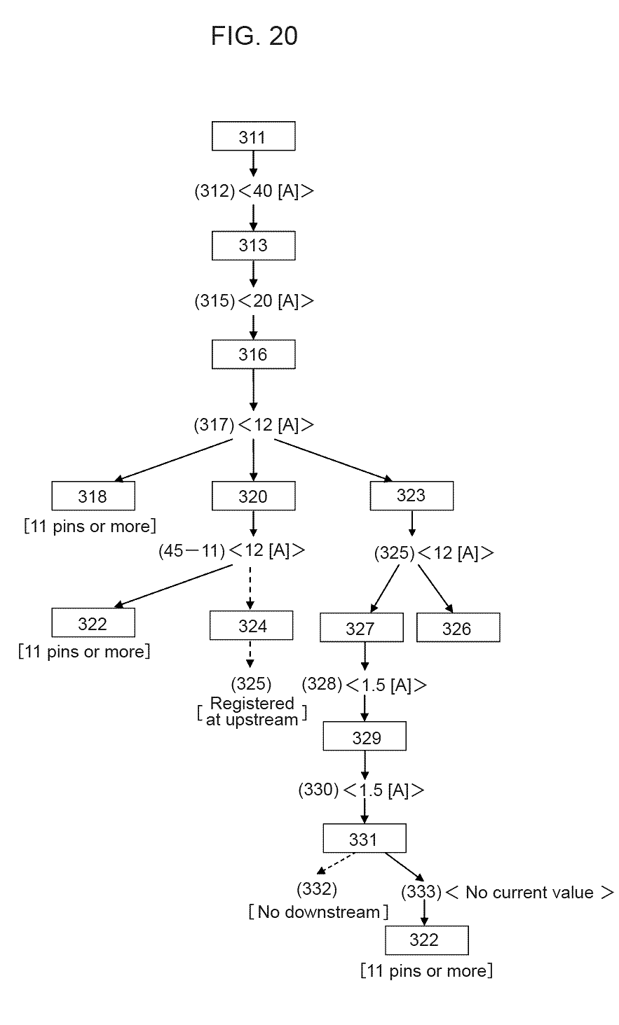

FIG. 19 is a table chart showing an example of the current path table to which the electric current value of the steady-state current is added. A current path table 149 in FIG. 19 is obtained when the input current value of the steady-state current is input, by adding the electric current value of the steady-state current, which is determined by the current value determination unit 133 executing the processing according to the flowchart in FIG. 18, to the current path table 148 shown in FIG. 16. The determined electric current value of the steady-state current is described in the path information column 149B in a row where “Wiring” is indicated in the component/wiring column 149A as shown in FIG. 19. Incidentally, “333” in the path information column 149B of FIG. 19 has “No Current Value.” This wiring 333 is described as a current path, but it has no electric current value, so that this wiring is excluded from objects for calculation of the current density described later. FIG. 20 is a conceptual diagram of a current path, which is indicated by the current path table in FIG. 19, in a tree structure. FIG. 20 shows the current paths and the electric current values indicated by the current path table 149 in FIG. 19 in an easily comprehensible way.

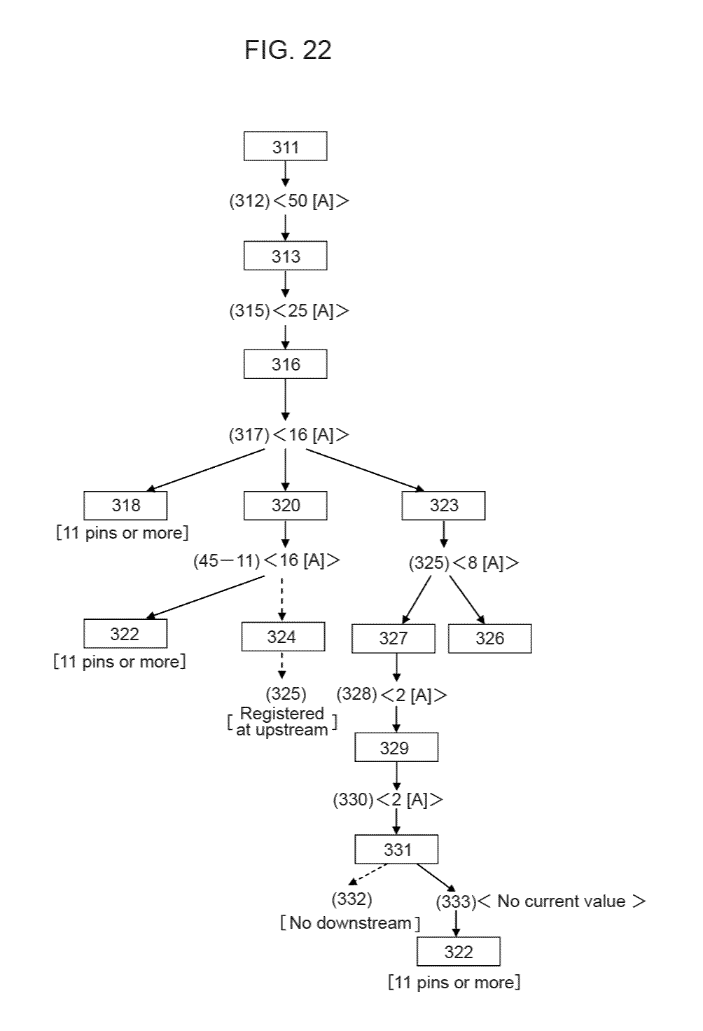

FIG. 21 is a table chart showing an example of the current path table to which the current value of the abnormal current is added. The current path table 150 in FIG. 21 is obtained when the input current value of the abnormal current is input, by adding the electric current value of the abnormal current, which is determined by the current value determination unit 133 executing the processing according to the flowchart in FIG. 18, to the current path table 148 shown in FIG. 16. Furthermore, FIG. 22 is a conceptual diagram of a current path, which is indicated by the current path table in FIG. 21, in a tree structure.

### (1-4-4) Determination of Copper Foil Plane Current Path

The current path determination unit 134 determines a current path in each copper foil plane which forms wiring (copper foil plane current path), by using the current path table created by the current path search unit 132. The current path determination unit 134 determines the copper foil plane current path so that the distance between its starting point and its end point, where the electric current flows within the copper foil plane, can be made as short as possible. However, like the wiring 312, 314, 315, 317, 319, 321, 325, 328, 330, 332, 333 as illustrated in FIG. 15, the copper foil planes which constitute wiring parts have various shapes, so that a method of determining the copper foil plane current path varies depending on the positions of the start and end points and the shape of the relevant copper foil plane.

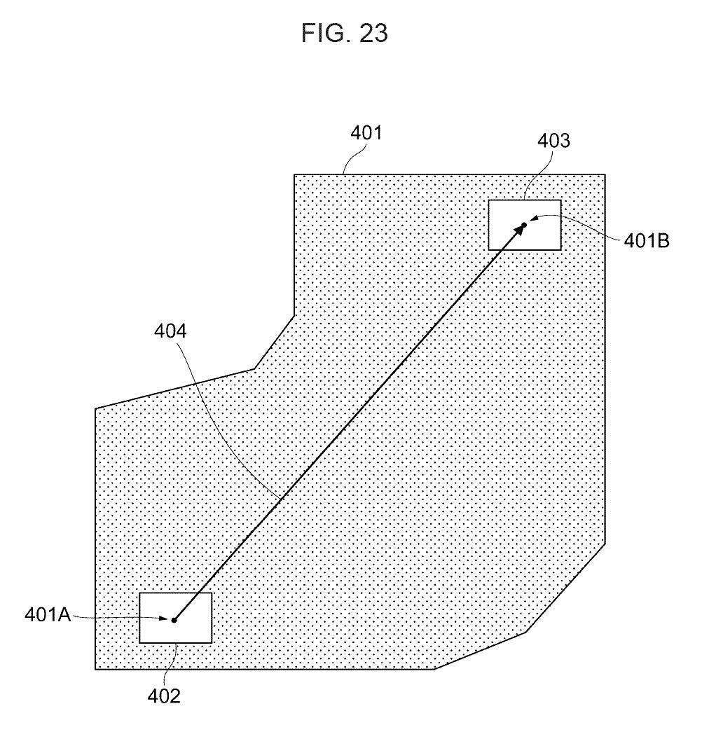

Examples of various shapes of the copper foil planes will be explained below and how the current path determination unit 134 determines a copper foil plane current path which connects a starting point and an end point in each copper foil plane will be explained. The shape of the copper foil plane can be determined based on the data acquired from the data storage unit 120 by the data acquisition unit 131. Furthermore, in FIG. 23 to FIG. 34, the same reference numeral is assigned to the same element and an explanation about it has been omitted.

(1-4-4-1) when Line Segment Connecting Starting Point and End Point Passes Through Inside Copper Foil Plane

FIG. 23 is an explanatory diagram showing an example of a copper foil plane. Inside a copper foil plane 401 shown in FIG. 23, provided are a pin 402 for mounting a component on the upstream side, and a pin 403 for mounting a component on the downstream side. A starting point 401A is a center coordinate of the pin 402 and shows the starting point of the current path in the copper foil plane 401. An end point 401B is a center coordinate of the pin 403 and shows the end point of the current path in the copper foil plane 401. A Line segment 404 is a line segment connecting the starting point 401A and the end point 401B.

The copper foil plane 401 shown in FIG. 23 is characterized in that one pin 402 for mounting a component on the upstream side and one pin 403 for mounting a component on the downstream side are provided and the line segment 404 which is a straight line connecting the starting point 401A and the end point 401B of the current path does not intersect with the periphery of the copper foil plane 401. Incidentally, in the following explanation, the state of “intersecting” does not include the state of overlapping. Accordingly, for example, even if the line segment 404 overlaps with the periphery of the copper foil plane 401, this is not recognized as intersecting with the periphery of the copper foil plane 401. With the copper foil plane 401 having such a feature, the current path determination unit 134 determines the line segment 404 as a current path in the copper foil plane 401.

(1-4-4-2) when Line Segment Connecting Starting Point and End Point Passes Through Outside Copper Foil Plane (1)

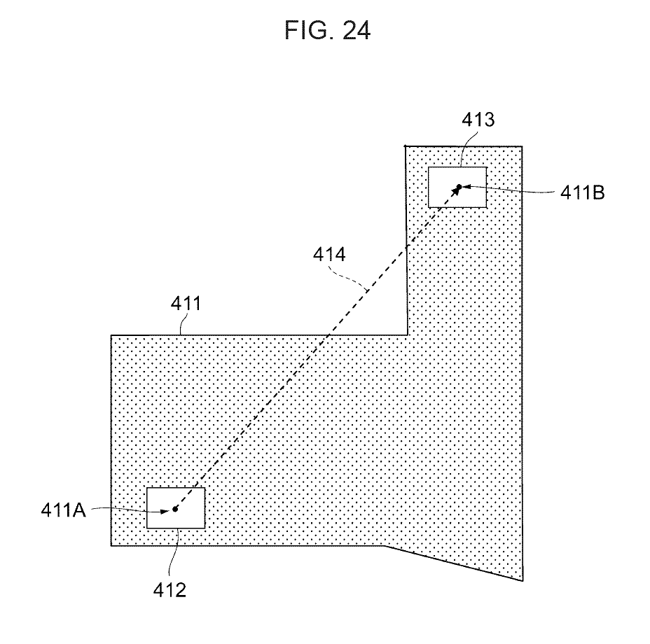

FIG. 24 is an explanatory diagram showing an example of a copper foil plane. Inside a copper foil plane 411 shown in FIG. 24, provided are a pin 412 for mounting a component on the upstream side, and a pin 413 for mounting a component on the downstream side. A starting point 411A is a center coordinate of the pin 412 and shows the starting point of the current path in the copper foil plane 411. An end point 411B is a center coordinate of the pin 413 and shows the end point of the current path in the copper foil plane 411. A Line segment 414 indicated as a broken line is a line segment connecting the starting point 411A and the end point 411B in the same manner as the line segment 404 in FIG. 23, but intersects with the periphery of the copper foil plane 411.

The copper foil plane 411 shown in FIG. 24 is characterized in that one pin 412 for mounting a component on the upstream side and one pin 413 for mounting a component on the downstream side are provided and the line segment 414 which is a straight line connecting the starting point 411A and the end point 411B of the current path intersects with the periphery of the copper foil plane 411. Since the copper foil plane 411 having such a feature cannot be defined as a current path, the current path determination unit 134 searches for the shortest path between the starting point and the end point.

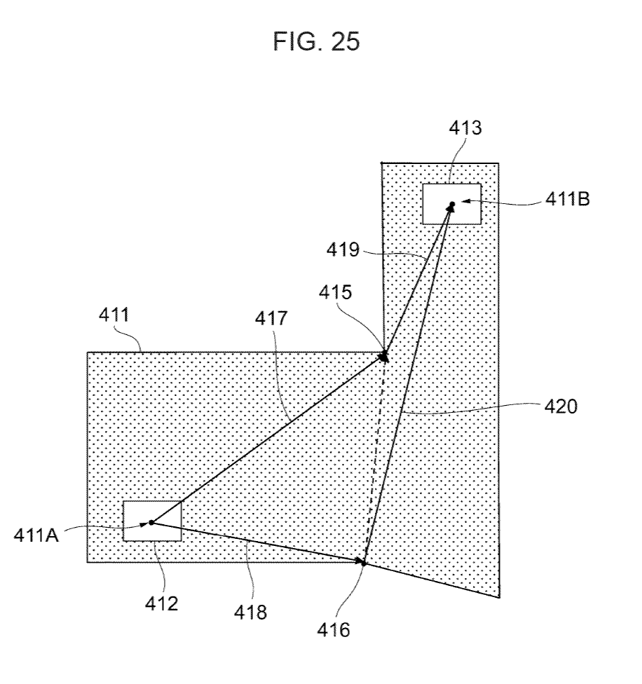

FIG. 25 is an explanatory diagram for explaining a method for determining a current path in the copper foil plane shown in FIG. 24. The method for determining a current path in the copper foil plane 411 will be explained with reference to FIG. 25.

Firstly, the current path determination unit 134 searches for a path by finding a vertex, whose interior angle exceeds 180 degrees, as a candidate for a relay point around the periphery of the copper foil plane 411. Referring to FIG. 25, there are two vertices 415, 416 whose interior angle exceeds 180 degrees. Next, the current path determination unit 134 draws a straight line from the starting point 411A to each of the vertices 415, 416 and selects only the vertex, whose line segment (corresponding to line segments 417, 418) does not intersect with the periphery of the copper foil plane 411, as a candidate for the relay point. Referring to FIG. 25, neither of the line segments 417, 418 intersect with the periphery of the copper foil plane 411, so that both the vertices 415, 416 are selected as candidates for the relay point.

Next, the current path determination unit 134 draws a straight line from each of the vertices 415, 416, which is the candidate for the relay point, to the end point 411B and sets only the vertex, whose line segment (corresponding to line segments 419, 420) does not intersect with the periphery of the copper foil plane 411, as the relay point. Referring to FIG. 25, neither of the line segments 419, 420 intersect with the periphery of the copper foil plane 411, so that both the vertices 415, 416 are selected as relay points. As a result, a path routed through the vertex 415 (the line segment 417 to the line segment 419) and a path routed through the vertex 416 (the line segment 418 to the line segment 420) become candidates for a current path connecting the starting point 411A and the end point 411B.

Finally, the current path determination unit 134 selects the shortest path from among the paths, which have become the candidates for the current path, and sets it as the current path for the copper foil plane 411. Referring to FIG. 25, the path routed through the vertex 416 is longer than the path routed through the vertex 415, so that the current path determination unit 134 sets the path connecting the starting point 411A and the end point 411B via the vertex 415 as the current path in the copper foil plane 411.

Incidentally, FIG. 25 has described the case where there is one relay point between the starting point 411A and the end point 411B; however, in a case where a line segment connecting a relay point and the end point intersects with the periphery of the copper foil plane 411, the current path determination unit 134 may determine the copper foil plane current path, which is routed through a plurality of relay points, by gradually searching for candidates for the relay points and determining the relay points.

### (1-4-4-3) Judgment of Interior Angle Size of Vertex of Copper Foil Plane

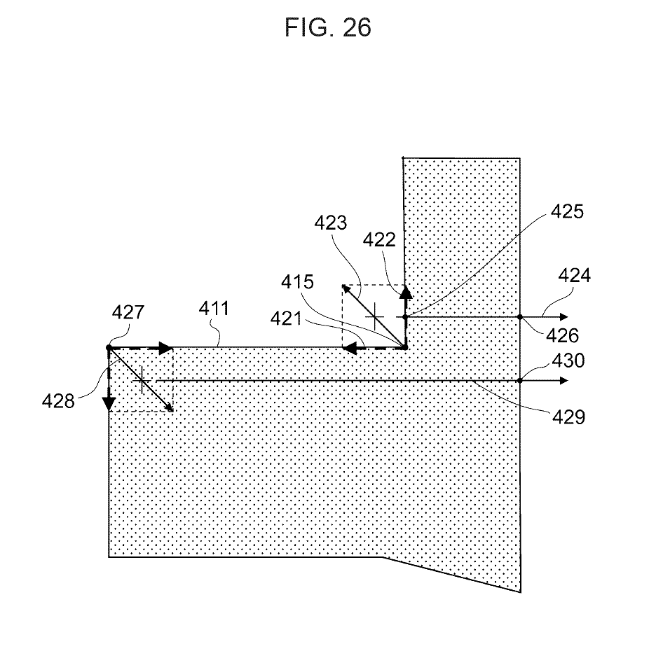

FIG. 26 is an explanatory diagram showing an example of a copper foil plane. With the copper foil plane 411 in FIG. 26, descriptions of the pin 412 and the pin 413 are omitted. A method for searching for a vertex of the copper foil plane whose interior angle size exceeds 180 degrees will be explained with reference to FIG. 26.

In order to find a vertex of the copper foil plane 411 whose interior angle size exceeds 180 degrees, the current path determination unit 134 uses the method described below for each vertex of the copper foil plane 411, thereby judging whether the interior angle size of each vertex exceeds 180 degrees or not. For example, the method for judging whether the interior angle size of each vertex exceeds 180 degrees or not will be explained with respect to the vertex 415.

Firstly, the current path determination unit 134 generates unit vectors 421, 422 whose starting point is the vertex 415. The length of the unit vectors 421, 422 should be sufficiently short as compared to a numeric value indicated by various data handled by the printed circuit board design data 121. For example, when the minimum unit of the data handled by the printed board design data 121 is micrometer, the length of the unit vectors 421 and 422 is 0.1 micrometers.

Next, the current path determining section 134 calculates a vector 423 which is obtained by adding the unit vector 422 to the unit vector 421 and whose starting point is the vertex 415. Then, the current path determination unit 134 selects a point other than the starting point on the vector 423 and draws a line segment 424 from the selected point as its starting point in a direction parallel to the coordinate system. For example, in the case of the X-Y coordinate system, the line segment 424 is a line segment parallel to the Y-axis or X-axis.

Then, the current path determination unit 134 calculates the number of intersections between the line segment 424 and the periphery of the copper foil plane line 411. If the number of intersections is an even number, the current path determination unit 134 determines that the size of the internal angle of the vertex 415 exceeds 180 degrees; and if the number of intersections is an odd number, the current path determination unit 134 determines that the size of the internal angle of the vertex 415 is less than 180 degrees. As shown in FIG. 26, the segments 424 intersects with the periphery of the copper foil plane 411 at two positions at points 425 and 426, the number of intersections is even and, therefore, it can be determined that the size of the internal angle of the vertex 415 exceeds 180 degrees.

On the other hand, considering a case where the same judgment is executed on a vertex 427, a vector 428 whose starting point is the vertex 427 is calculated by synthesizing unit vectors and a line segment 429 is drawn from a point on the vector 428 other than the vertex 427 in a direction parallel to the coordinate system. As shown in FIG. 26, the segment 429 intersects with the periphery of the copper foil plane 411 at only one position at a point 430. Therefore, the number of intersection becomes an odd number and the current path determination unit 134 determines that the interior angle size at the vertex 427 is equal to or less than 180 degrees.

(1-4-4-4) when Line Segment Connecting Starting Point and End Point Passes Through Outside Copper Foil Plane (2)

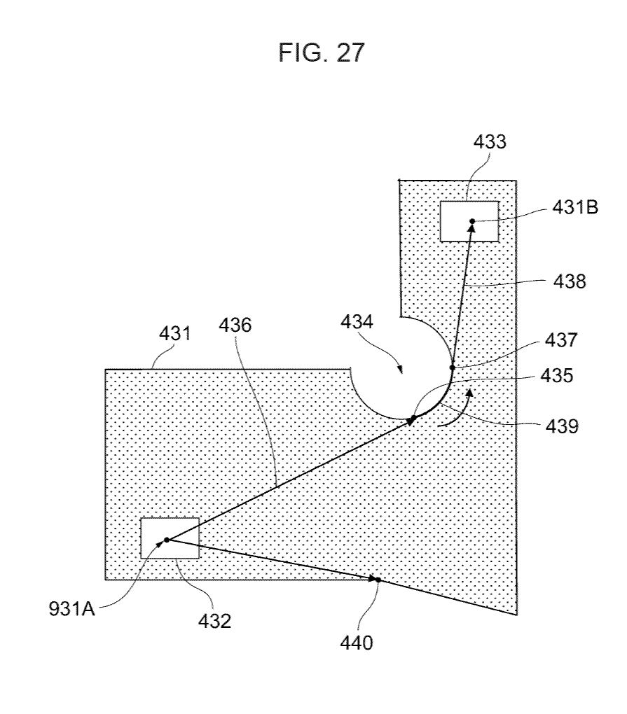

FIG. 27 is an explanatory diagram showing an example of a copper foil plane. Inside a copper foil plane 431 shown in FIG. 27, provided are a pin 432 for mounting a component on the upstream side, and a pin 433 for mounting a component on the downstream side. A starting point 431A is a center coordinate of the pin 432 and shows the starting point of the current path in the copper foil plane 431. An end point 431B is a center coordinate of the pin 433 and shows the end point of the current path in the copper foil plane 431. The copper foil plane 431 is shaped into a circle 434 which is partly cut out around its central area and a line segment which is a straight line connecting the starting point 431A and the end point 431B intersects with the circle 434 and passes outside of the copper foil plane 431.

The copper foil plane 431 shown in FIG. 27 is characterized in that one pin 432 for mounting a component on the upstream side and one pin 433 for mounting a component on the downstream side are provided and the line segment which is a straight line connecting the starting point 431A and the end point 431B of the current path passes through the circular part (circle 434), which is made by cutting out the copper foil plane 431, thereby intersecting with the periphery of the copper foil plane 431.

In this case, the current path determination unit 134 draws a tangential line from the starting point 431A to the circle 434 and determines a contact point 435 on the circumference of the circle 434 as a relay point. A line segment 436 is a tangential line from the starting point 421A to the circle 434 and is a line segment connecting the starting point 431A and the contact point 435. Next, the current path determination unit 134 also draws a tangential line from the end point 431B to the circle 434 in the same manner and determines a contact point 437 on the circumference of the circle 434 as a relay point. The line segment 438 is a tangential line from the end point 421B to the circle 434 and is a line segment connecting the end point 421B and the contact point 437. Then, the current path determination unit 134 connects the contact point 435 and the contact point 437, which are the relay points, via an arc 439 and determines a path routed through the line segment 436, the arc 439, and then the line segment 438 as the copper foil plane current path.

(1-4-4-5) when Plurality of Pins Exist in Copper Foil Plane

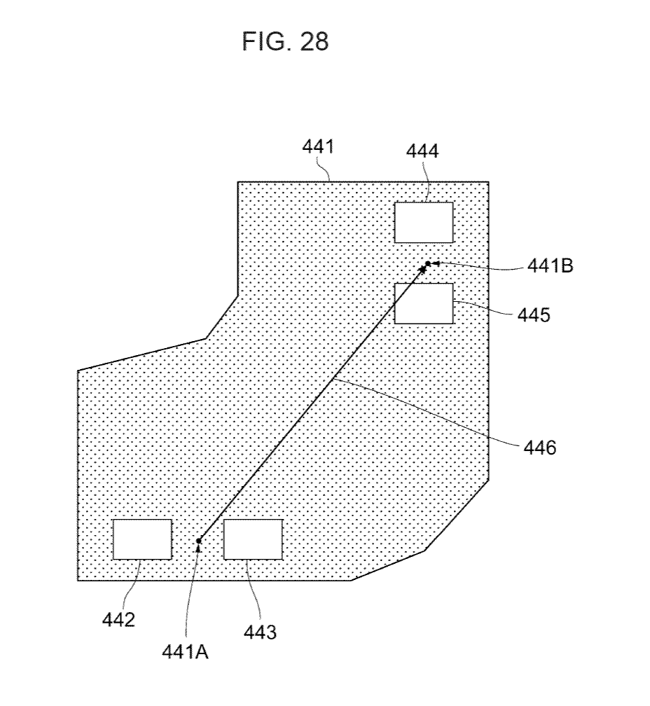

FIG. 28 is an explanatory diagram showing an example of a copper foil plane. Inside a copper foil plane 441 shown in FIG. 28, provided are pins 442, 443 for mounting a component on the upstream side, and a pin 444, 445 for mounting a component on the downstream side. A starting point 441A shows the starting point of the current path in the copper foil plane 441 and an end point 441B shows the end point of the current path in the copper foil plane 441.

The copper foil plane 441 shown in FIG. 28 is characterized in that a plurality of pins 442, 443 for mounting a component on the upstream side and a plurality of pins 444, 445 for mounting a component on the downstream side are provided. Regarding the copper foil plane 441 having such a feature, the current path determination unit 134 calculates an average value of center coordinates of the pins 442, 443 mounted on the component on the upstream side and sets a coordinate point, which is represented by the calculated average value, as the starting point 441A. Furthermore, the current path determination unit 134 calculates an average value of center coordinates of the pins 444, 445 mounted on the component on the downstream side and sets a coordinate point, which is represented by the calculated average value, as the end point 441B.

Regarding the copper foil plane 441 shown in FIG. 28, a line segment 446 connecting the starting point 441A and the end point 441B does not intersect with the periphery of the copper foil plane 441, so that the current path determination unit 134 determines the line segment 446 as the current path. Furthermore, if the line segment 446 intersects with the periphery of the copper foil plane 441; the current path determination unit 134 determines the copper foil plane current path according to the aforementioned method.

(1-4-4-6) when Pin for Upstream and Pin for Downstream Exist in Different Layers of Copper Foil Planes

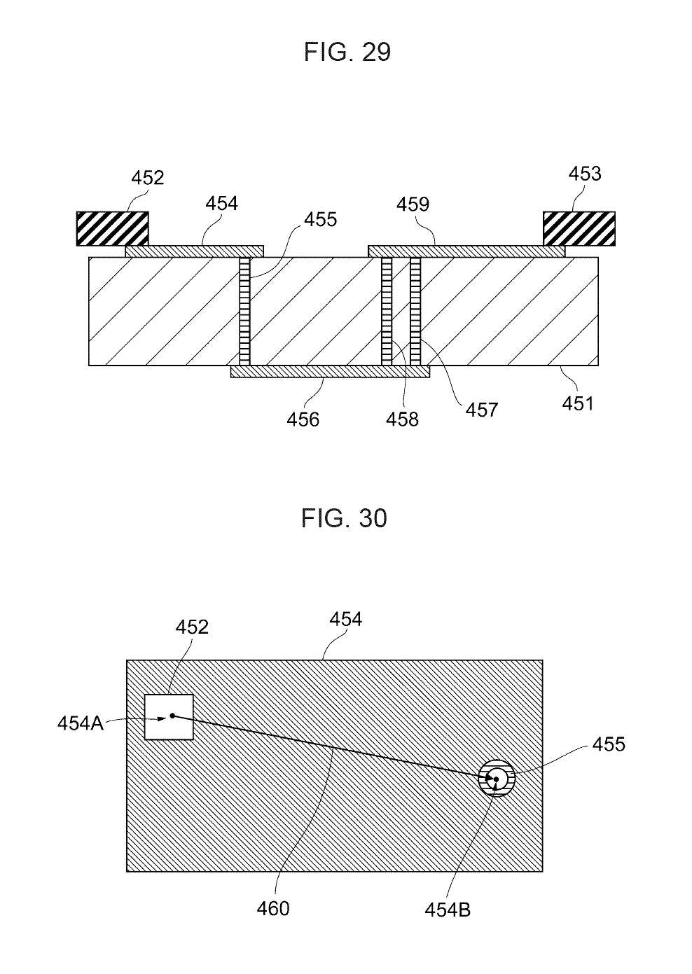

FIG. 29 is a sectional view of one example of a printed circuit board. With the printed circuit board shown in FIG. 29, copper foil planes 454, 459 are provided above an upper surface of an insulating layer 451, a pin 452 for a component which becomes a starting point of a current path is connected to the copper foil plane 456, and a pin 453 for a component which becomes a starting point of a current path is provided on the copper foil plane 459. Moreover, a copper foil plane 456 is provided on a lower surface of the insulating layer 451 and a via 455 for connecting the copper foil plane 454 and the copper foil plane 456 is formed in and pierces through the insulating layer 451. Furthermore, with the printed circuit board shown in FIG. 29, two vias 457, 458 for connecting the copper foil plane 459 and the copper foil plane 456 are formed in and pierce through the insulating layer 451. In the following explanation, a method for determining a current path in the copper foil plane 454 and a current path in the copper foil plane 456 with respect to the printed circuit board shown in FIG. 29 will be explained.

FIG. 30 is a conceptual diagram of a portion of the printed circuit board shown in FIG. 29 as seen from above. Inside the copper foil plane 454 shown in FIG. 30, the pin 452 for mounting a component on the upstream side and the via 455 are provided. A starting point 454A is a center coordinate of the pin 452 and indicates a starting point of a current path in the copper foil plane 454. An end point 454B is a center coordinate of the via 455 and indicates an end point of a current path in the copper foil plane 454.

The copper foil plane 454 shown in FIG. 30 is characterized in that one pin 452 for mounting a component on the upstream side is provided and no pin for mounting a component on the downstream side is provided. With the copper foil plane 454 having such a feature, the current path determination unit 134 recognizes the via 455 as a pin for mounting a compound on the downstream side and determines a copper foil plane current path by setting the center coordinate of the pin 455 as the end point. Incidentally, if there are two or more vias, the current path determination unit 134 recognizes a via with the longest path length from the center coordinate of the pin for mounting the component on the upstream side, as the end point of the current path. Furthermore, in a case of a copper foil plane in which a pin for mounting a component on the downstream side exists and no pin for mounting a component on the upstream side exists, the current path determination unit 134 may recognize the via as the pin for mounting a component on the upstream side and calculate the coordinates of the starting point in the same manner as in the case of the copper foil plane 454.

After determining the starting point and the end point of the copper foil plane current path, the current path determination unit 134 determines the copper foil plane current path using the various methods described above, depending on the shape of the copper foil plane. Furthermore, in a case where either the pin for mounting a component on the upstream side or the pin for mounting a component on the downstream side exists, but no via exists, the current path determination unit 134 determines there is no flow path of the electric current; and therefore, the current path determination unit 134 does not calculate the copper foil plane current path or the current density.

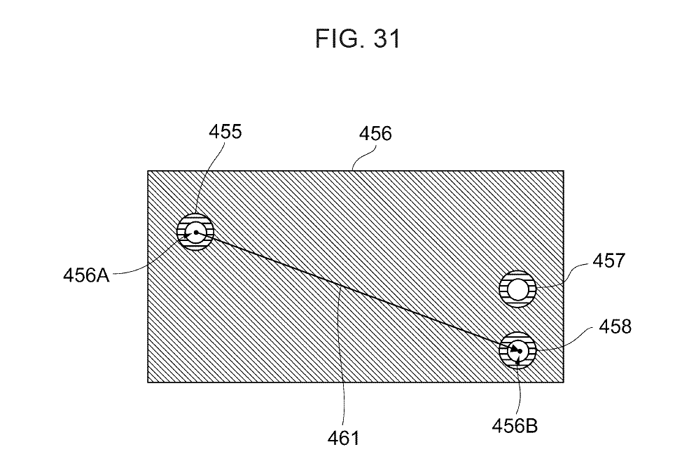

FIG. 31 is a conceptual diagram of the printed circuit board shown in FIG. 29 as seen from below. The vias 455,457,458 are provided inside the copper foil plane 456 shown in FIG. 31. A starting point 456A is a center coordinate of the via 455 and indicates a starting point of a current path in the copper foil plane 456. An endpoint 456B is a center coordinate of the via 458 and indicates an end point of the current path in the copper foil plane 456.

The copper foil plane 456 shown in FIG. 31 is characterized in that neither a pin for mounting a component on the upstream side nor a pin for mounting a component on the downstream side exists and a plurality of vias exist. With the copper foil plane 456 having such a feature, the current path determination unit 134 tries all combinations of arbitrary two vias as the starting point and the end point of the copper foil plane current path, selects a combination of the vias with the longest path length, and determines a path connecting the selected vias as the starting point and the end point to be the current path in the copper foil plane 456. Referring to FIG. 31, the path length of a combination of the via 455 and the via 458 is the longest, so that the current path determination unit 134 determines a line segment 461, which connects the starting point 456A and the end point 456B, as the current path in the copper foil plane 456.

Incidentally, if neither a pin for mounting a component on the upstream side nor a pin for mounting a component on the downstream side exists and the number of vias is one or less, the current path determination unit 134 determines there is no flow path of the electric current; and therefore, the current path determination unit 134 does not calculate the copper foil plane current path or the current density.

As explained above with reference to FIG. 23 to FIG. 31, the current path determination unit 134 can determine the copper foil plane current path in each copper foil plane, which forms wiring for a current path in the printed circuit board, depending on various shapes of the copper foil plane by executing the processing according to the shape of the copper foil plane and the positions of the starting point and the end point to which the electric current is supplied to the copper foil plane.

### (1-4-5) Calculation and Judgment of Current Density

The current density calculation unit 135 calculates a current density of a wiring part of a current path in the printed circuit board by calculating the current density in each copper foil plane, which forms wiring of the current path in the printed circuit board, based on the current path table 149 (or 150), to which the electric current value is added by the current value determination unit 133, and the copper foil plane current path determined by the current path determination unit 134.

### (1-4-5-1) Calculation of Current Path Width (1)

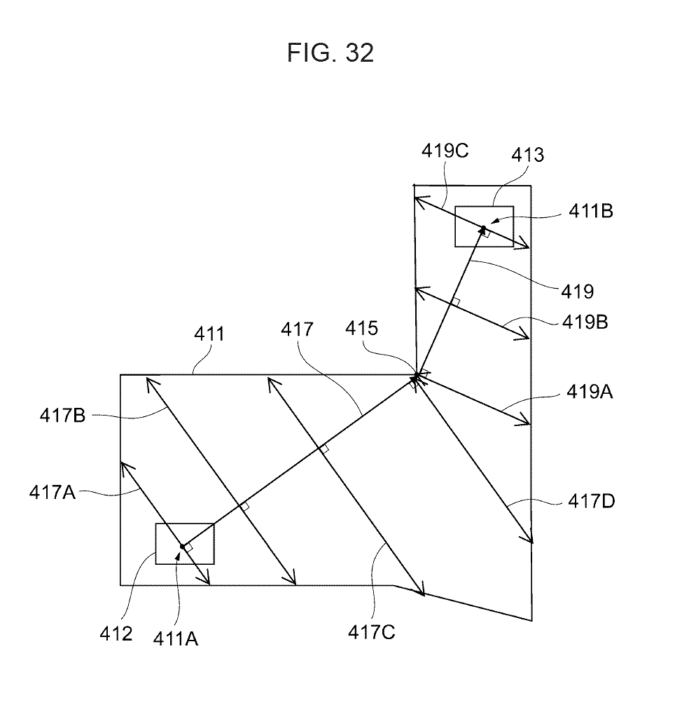

Firstly, the current density calculating unit 135 calculates the minimum value of a current path width required to calculate the current density. The current path width is the width of a copper foil surface relative to the copper foil plane current path and corresponds to the copper foil length in a direction perpendicular to the copper foil plane current path. FIG. 32 is an explanatory diagram for explaining a method for calculating the minimum value of the current path width. The copper foil plane 411 shown in FIG. 32 is the copper foil plane shown in FIG. 25 and descriptions about any redundant parts have been omitted. With the copper foil plane 411, the line segments 417, 419 which connect the starting point 411A and the end point 411B by way of the via point 415 are determined to be the copper foil current path by the current path determination unit 134. The method executed by the current density calculation unit 135 for calculating the current path width will be explained with reference to FIG. 32.

Firstly, the current density calculation unit 135 draws a vertical line 417A, which is perpendicular to the line segment 417, that is, the copper foil plane current path, from the starting point 411A and recognizes the distance between intersections with the periphery of the copper foil plane 411 as the current path width. Specifically speaking, the current path width at the starting point 411A corresponds to the length of the vertical line 417A. Next, the current density calculation unit 135 draws a vertical line 417B in the same manner as with the starting point 411A, at a point moved along the line segment 417 from the starting point 411A for a specified minute section (for example, 0.05 mm) towards the end point side (check point). Then, the current density calculation unit 135 calculates the length of the vertical line 417B; and if the length of the vertical line 417B is a smaller value than the line segment 417A, the current density calculation unit 135 updates the current path width.

Then, as the current density calculation unit 135 moves the check point along the copper foil plane current path towards the end point side by the specified minute section, it calculates the length of a vertical line 417C to 417D and 419A to 419B at each check point and repeats the processing for updating the current path width with the minimum value. Incidentally, regarding a check point like the vertex 415 where a plurality of vertical lines can be drawn, the current density calculation unit 135 calculates the length of the plurality of vertical lines. Specifically speaking, for example, such vertical lines are a vertical line 417D for the line segment 417 and a vertical line 419D for the line segment 419 at the vertex 415.

Finally, when the check point reaches the end point 411B, the current density calculation unit 135 draws a vertical line 419C at the end point 411B and calculates the length of the vertical line 419C; and if the length of the vertical line 419C is the minimum value, the current density calculation unit 135 updates the current path width and terminates moving along the copper foil plane current path. As a result, the minimum value of the length of the vertical line calculated with respect to the copper foil plane current path is determined as the current path width. Referring to FIG. 32, the lengths of the vertical lines 419A to 419C indicate the same minimum value, which is determined as the current path width.

### (1-4-5-2) Calculation of Current Path Width (2)

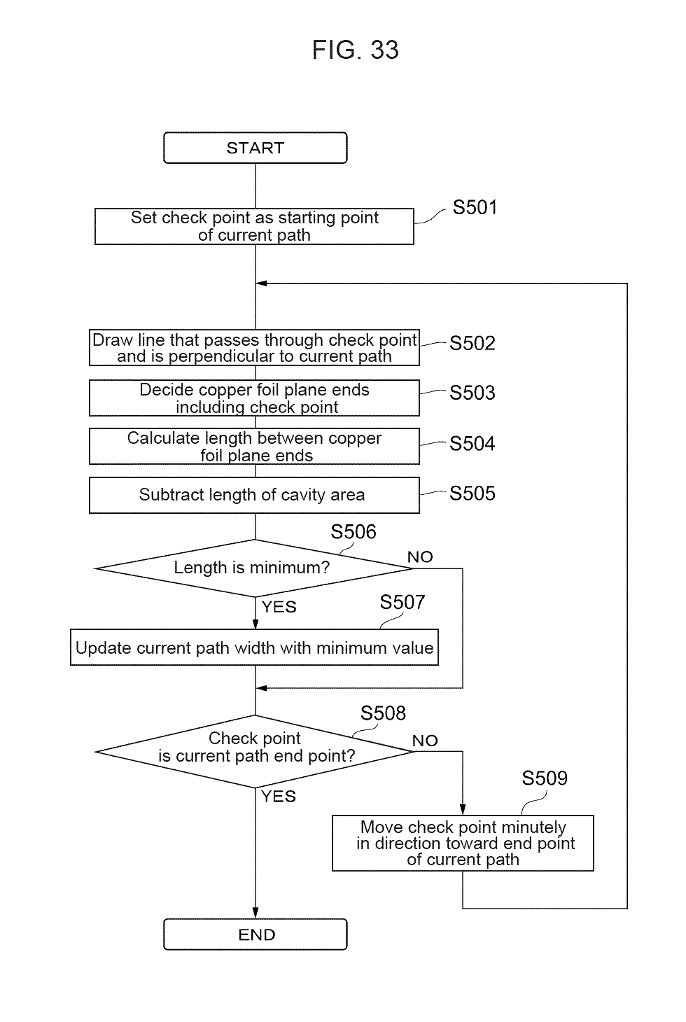

FIG. 33 is a flowchart showing an example of a processing sequence for calculating the minimum value of the current path width. The current density calculation unit 135 can realize the calculation of the minimum value of the current path width described with reference to FIG. 32 by executing the processing illustrated in FIG. 33. In the processing illustrated in FIG. 33, the shape of the copper foil plane which is determined based on the data acquired from the data storage unit 120 by the data acquisition unit 131, and information about the copper foil plane current path which is determined by the current path determination unit 134 (including information indicating the starting point and the end point of the copper foil plane current path) are input in advance.

Firstly, the current density calculation unit 135 sets a check point as a starting point of the copper foil plane current path (step S501). Then, the current density calculation unit 135 draws a line which passes through the check point set in step S501 and is perpendicular to the copper foil plane current path (step S502). Subsequently, the current density calculation unit 135 calculates a point where the vertical line which was drawn in step S502 intersects with the copper foil plane, and determines terminal points of the copper foil plane with respect to the vertical line (step S503).

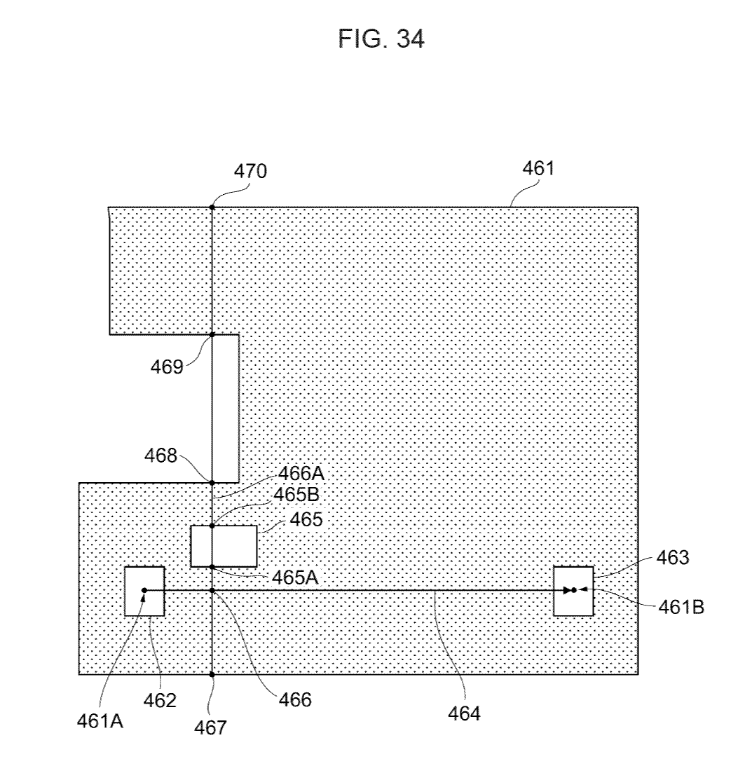

Now, FIG. 34 is an explanatory diagram showing an example of a copper foil plane. The terminal points of the copper foil plane with respect to the vertical line will be explained with reference to FIG. 34. A copper foil plane 461 shown in FIG. 34 is provided with a pin 462 for mounting a component on the upstream side and a pin 463 for mounting a component on the downstream side. A line segment 464 indicates a copper foil plane current path in the copper foil plane 461 and is a straight line connecting a starting point 461A and an end point 461B. Furthermore, a cavity 465 is a cavity area where no copper foil exists in the copper foil plane 461.

Referring to FIG. 34, a vertical line 466A is a line perpendicular to the copper foil plane current path (the line segment 464) at a check point 466. The vertical line 466A intersects with the periphery of the copper foil plane 461 at four positions of points 467 to 470 and intersects with the cavity 465 at points 465A, 465B. Since under this circumstance the check point 466 exists between the point 467 and the point 468, the current calculation unit 135 determines the points 467, 468 to be terminal points of the copper foil plane 461 with respect to the vertical line 466A. Since the check point 466 does not exist between the point 469 and the point 470, the current calculation unit 135 does not recognize the points 469, 470 as terminal points of the copper foil plane 461 with respect to the vertical line 466A. Furthermore, since the points 465A, 465B are intersections with the cavity area in the copper foil plane 461, the current calculation unit 135 does not recognize the points 465A, 465B as terminal points of the copper foil plane 461, either.

When the terminal point of the copper foil plane is determined in step S503, the current density calculation unit 135 calculates the length between the terminal points of the copper foil plane (step S504). Referring to FIG. 34 as an example, the length between the terminal points of the copper foil plane is the length between the point 467 and the point 468. Then, if a cavity area exists between the terminal points of the copper foil plane, the current density calculation unit 135 subtracts the length of the cavity area from the length between copper foil plane ends calculated in step S504 (step S505). Referring to FIG. 34 as an example, the vertical line 466A has intersections 465A, 465B with the cavity area between the point 467 and the point 468 which are the terminal points of the copper foil plane, so that the current density calculation unit 135 subtracts the length between the point 465A and the point 4658 indicative of the length of the cavity area from the length between the point 467 and the point 468 indicate of the length between the copper foil plane ends.

Next, the current density calculation unit 135 compares the length calculated by the processing in steps no later than S505 with the value of the current path width, which has been retained, and judges whether it is the minimum value or not (step S506). The current path width is, for example, a value retained in the main storage unit 12 and its initial value is set as 0. If the calculated value is not the minimum value of the current path width in step S506, the processing proceeds to step S508. If the calculated value is the minimum value of the current path width in step S506 (YES in step S506), the current density calculation unit 135 updates the current path width with the calculated value (step S507) and the processing proceeds to step S508. For example, if the check point is the starting point of the copper foil plane current path, the value of the current path width is 0 and, therefore, the current density calculation unit 135 retains the length, which was calculated by the processing in steps no later than S505, as the current path width.

In step S508, the current density calculation unit 135 judges whether the check point is the end point of the copper foil plane current path or not (step S508); and if the check point is the end point (YES in step S508), the current density calculation unit 135 terminates the processing. If the check point is not the end point of the copper foil plane current path (NO in step S508), the current density calculation unit 135 moves the check point along the copper foil plane current path by every specified minute section in a direction towards the end point (step S509) and repeats the processing in step 502 and subsequent steps.

The current density calculation unit 135 can calculate the minimum value of the current path width of the copper foil plane current path by executing the processing from step S501 to step S509 described above.

### (1-4-5-3) Calculation of Current Density

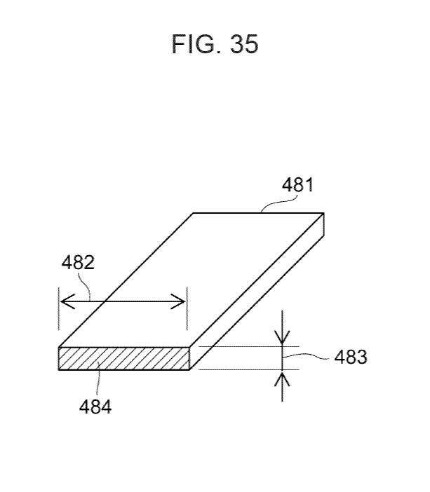

FIG. 35 is a schematic diagram for explaining the current density. A copper foil 481 shown in FIG. 35 is a copper foil which forms a copper foil plane. The width of the copper foil 481 corresponds to a current path width 482 calculated by the current density calculation unit 135. A copper foil thickness 483 is the thickness of the applied copper foil and is a value which can be set in advance.

The current density of the copper foil plane herein used is equal to a value obtained by dividing the value of the electric current flowing through the copper foil plane by a cross-sectional area of the copper foil plane. The value of the electric current flowing through the copper foil plane is equal to an electric current value determined by the current value determination unit 133. Then, the cross-sectional area of the copper foil plane is represented by multiplying the current path width 482 by the copper foil thickness 483 in FIG. 35. Therefore, referring to FIG. 35 as an example, the current density calculation unit 135 calculates the current density by dividing the value of the electric current flowing through the copper foil plane 481, which was determined by the current value determination unit 133, by the current path width 482 and further dividing the obtained value by the copper foil thickness 483.

Accordingly, the current density calculation unit 135 calculates the current density in wiring parts of the current path in the printed circuit board by calculating the current density in each copper foil plane which forms wiring in the current path in the printed circuit board. Then, the current density calculation unit 135 calculates the current density in each wiring, which constitutes the current path, and outputs the calculation results to a calculation result list.

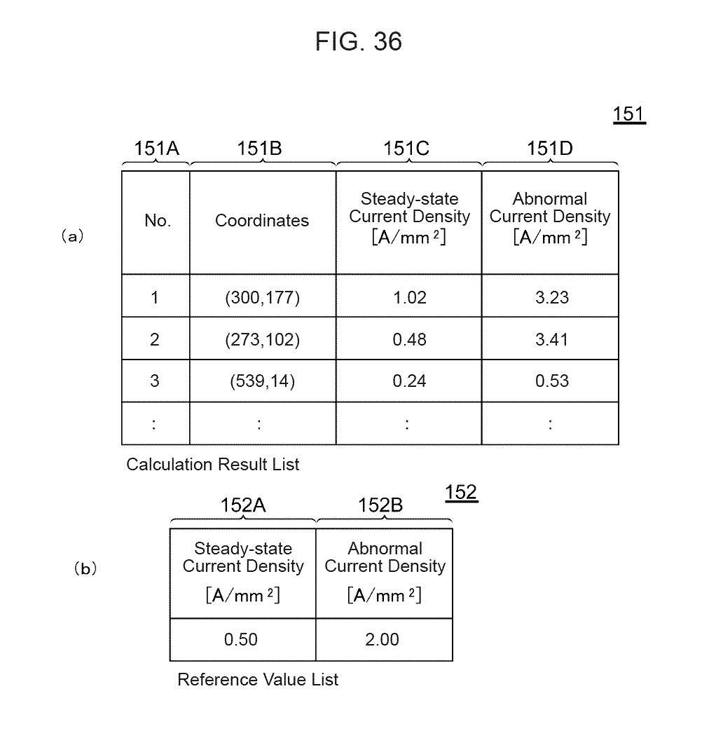

FIG. 36(a) is a data diagram showing an example of the calculation result list. A calculation result list 151 is constituted from a number column 151A, a coordinates column 151B, a steady-state current density column 151C, and an abnormal current density column 151D. The coordinates column 151B describes coordinates indicated by wiring for which the current density is calculated. For example, coordinates of a starting point of the current path with respect to the relevant wiring may be used or other coordinates which can specify the relevant wiring may be used as the coordinates indicative of the wiring. The steady-state current density column 151C describes the calculation result of the current density when the calculation is performed by using the steady-state current; and the abnormal current density column 151D describes the calculation result of the current density when the calculation is performed by using the abnormal current. The calculation result list 151 is stored in, for example, the main storage unit 12.

### (1-4-6) Creation of Rejected Part List

The rejected part list creation unit 136 judges whether the current density calculated by the current density calculation unit 135 is within an allowable range which satisfies a designed value or not, and then creates and outputs a list of parts determined to be rejected (current path).

FIG. 36(b) is a data diagram showing an example of a reference value list. The reference value list 152 is a list of designed values which are set and stored as an allowable range of a current density at the time of designing, and is input and stored in, for example, the data storage unit 120 in advance. The reference value list 152 may be acquired together with data stored in the data storage unit 120 when the data acquisition unit 131 acquires such data from the data storage unit 120, or may be acquired by the rejected part list creation unit 136 from a place whether the reference value list 152 is stored.

The reference value list 152 shown in FIG. 36 is constituted from: a steady-state current density column 152A which describes a designed value of the current density in a case of the steady-state current; and an abnormal current density column 152B which describes a designed value of the current density in a case of the abnormal current; however, the reference value list 152 may be a list that designates upper and lower limits of the steady-state current value and the abnormal current value.

The rejected part list creation unit 136 compares the calculation result list 151 created by the current density calculation unit 135 with the reference value list 152 and judges whether the current density calculated by the current density calculation unit 135 complies with the designed value described in the reference value list 152 or not. Then, the rejected part list creation unit 136 determines that the current density out of the allowable range of the designed value described in the reference value list 152 should be rejected; and collects information about the current density, which has been determined to be rejected, in the rejected part list.

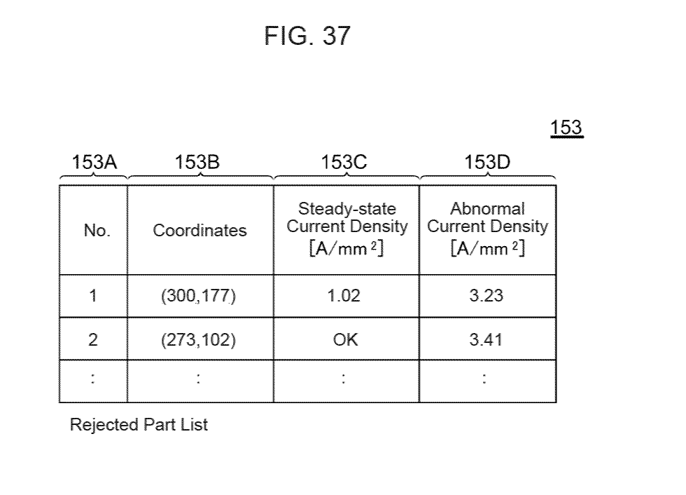

FIG. 37 is a data diagram showing an example of the rejected part list. A rejected part list 153 is constituted from a number column 153A, a coordinates column 153B, a steady-state current density column 153C, and an abnormal current density column 153D in the same manner as the calculation result list 151 shown in FIG. 36(a). The coordinates column 152B describes coordinates which can identify wiring corresponding to a current density which was determined to be rejected; and the steady-state current density column 153C and the abnormal current density column 153D describe the current density which was determined to be rejected. Incidentally, if either the steady-state current density or the abnormal current density is determined to be rejected, a description such as “OK” as shown in FIG. 37 may be used with respect to a current density which is not rejected, that is, which is within the allowable range of the designed value.

Incidentally, the calculation result list 151 in FIG. 36(a) and the rejected part list 153 in FIG. 37 are provided with the coordinates column 151B, 153B as information for identifying the relevant wiring, but may be designed so that information, other than coordinates, which can identify wiring (such as a wiring name) may be described.

Finally, the rejected part list creation unit 136 sends the created rejected part list 153 to the output device 30 and the output device 30 outputs a verification result by the printed circuit board design verification system 1 based on the received rejected part list 153. The output of the verification result by the output device 30 may be, for example, displayed on a display or printed by using a printer function, or other general output methods may be applied.

### (1-5) Advantageous Effects of this Embodiment

With the printed circuit board design verification system 1 described above, the design verification unit 130 can calculate the current density of wiring parts of the copper foil planes in the printed circuit board based on the printed circuit board design data 121, the input current value 122, the GND wiring name 123, the component current value 124, and the wiring current value 125 which are input to the data storage unit 120; and the design verification unit 130 can select wiring parts to be rejected (rejected parts) which do not satisfy the judgment criterion by judging whether the calculated current density is within the allowable range of the designed value or not. The printed circuit board design verification system 1 can select the rejected parts of the current density by assuming the printed circuit board with the components mounted thereon, by verifying the current density of the printed circuit board based on the design data of the printed circuit board, so that it is possible to prevent the occurrence of degradation or breakage of wiring and components, to which the wiring connects, due to heat generation caused upon supply of the electric current.

Furthermore, with such printed circuit board design verification system 1, it is possible to design a printed circuit board in which an inappropriate current density will not occur, by directly or interactively modify the printed circuit board, regarding which any rejected parts of the current density have been output, and then re-verifying the modified printed circuit board. As a result, the problem of an excessive current density can be solved before manufacturing the printed circuit board. So, as compared to a case where the problem of an excessive current density is exposed after manufacturing the printed circuit board and mounting components on it, it is unnecessary to redesign the printed circuit board after it is manufactured; and it is thereby possible to curb the design process in a short period of time.

Moreover, with such printed circuit board design verification system 1, the current density can be verified in the case where not only the steady-state current, but also the abnormal current is supplied to the printed circuit board. So, it is possible to judge the possibility in advance that when the abnormal current occurs, the current density in excess of the designed value may occur and a protection component such as a fuse may burn out. Then, it is possible to modify the printed circuit board before manufacturing it to make the current density fall within the allowable range of the designed value upon the occurrence of the abnormal current, by modifying the wiring, regarding which it is determined that an inappropriate abnormal current density will occur; and, therefore, it is possible to realize secure protection of products by the component such as the fuse.

Furthermore, if such printed circuit board design verification system 1 is used, the amount of information about the copper foil planes will gradually increase as the designing process proceeds. So, in a stage where copper foil plane information which makes it possible to identify a current path in the printed circuit board can be input, whether the current density would be excessive or not can be judged with respect to the manufactured printed circuit board which can be assumed at present even in a mid-course stage before the completion of designing of the printed circuit board. Therefore, it is possible to perform modification in the mid-course stage of designing and proceed with designing to make the current density fall within the allowable range of the designed value, and prevent rework due to redesigning after the manufacture of the printed circuit board; and the advantageous effect of reducing the total process time required for designing of the printed circuit board can be expected.

### (2) Other Embodiments

Incidentally, regarding the printed circuit board design verification system 1 according to an embodiment described above, the case where the input device 20 and the output device 30 are configured separately from the computer 10 has been described; however, the present invention is not limited to this example and, for example, the input device 20 and the output device 30 may be integrated with the computer 10. With such printed circuit board design verification system, the current density of the printed circuit board can be verified by using one information processing unit.

Furthermore, regarding the printed circuit board design verification system 1 according to an embodiment described above, the case where the design data about the printed circuit board (for example, the printed circuit board design data 121 and the input current value 122) are input from the input device 20 and stored in the data storage unit 120, and the data storage unit 120 is a recording medium of at least either the main storage unit 12 or the auxiliary storage unit 13 has been described; however, the present invention is not limited to this example and may be configured so that, for example, a database for storing data may be provided separately from the computer 10 and the design data about the printed circuit board may be input and stored from the input device 20 into the database. Under this circumstance, the data acquisition unit 131 may acquire necessary information from the database at the start of the verification processing by the design verification unit 130. Such printed circuit board design verification system can accumulate the design data of printed circuit boards from time to time regardless of the operation status of the computer 10, so that the advantageous effect of enhancing the convenience of the entire system can be expected.

Furthermore, regarding the printed circuit board design verification system 1 according to an embodiment described above, the case where a plurality of pieces of the printed circuit board design data 121 are collected and configured in the table structure like the component data table 141 shown in FIG. 3 has been described; however, the present invention is not limited to this example and, for example, the printed circuit board design data 121 may be configured by including two-dimensional data or three-dimensional data about components. Furthermore, the format of each piece of data stored in the data storage unit 120 is not limited to the table format. The printed circuit board design verification system which is configured in this way can use data of various formats as the design data of the printed circuit boards.

Furthermore, regarding the printed circuit board design verification system 1 according to an embodiment described above, the case where a wiring part of the printed circuit board is formed of a copper foil plane has been described; however, the present invention is not limited to this example and wiring which is formed by using electrically conductive metal other than copper may be used as the wiring of the printed circuit board. Under this circumstance, for example, in a case of wiring which uses aluminum instead of a copper foil (aluminum wiring), the current density calculation unit may calculate a current density of a wiring part(s) based on an electric current value which is input to aluminum wiring, the current path width of an aluminum foil, and the applied aluminum foil thickness.

### REFERENCE SIGNS LIST

1 printed circuit board design verification system
10 computer
11 central processing unit
12 main storage unit
13 auxiliary storage unit
14 input/output interface
110 control unit
120 data storage unit
130 design verification unit
131 data acquisition unit
132 current path search unit
133 current value determination unit
134 current path determination unit
135 current density calculation unit
136 rejected part list creation unit
20 input device
30 output device

1. A printed circuit board design verification system comprising:
an input unit for inputting printed circuit board design data indicative of data determined by no later than a mid-course stage or it subsequent stage of designing of a printed circuit board, and printed circuit board manufacturing data indicative of data required when manufacturing the printed circuit board;
a data storage unit for storing the printed circuit board design data and the printed circuit board manufacturing data which have been input from the input unit;
a design verification unit for calculating a current density in a current path of the printed circuit board, when manufactured, based on the printed circuit board design data and the printed circuit board manufacturing data, which are stored in the data storage unit, and judging whether a rejected part of wiring in which the current density in excess of an allowable range defined as a designed value occurs exists in the current path or not, by referring to the calculated current density; and
an output unit for outputting information indicative of the rejected part of the wiring which has been judged by the design verification unit;
wherein the design verification unit:
acquires the printed circuit board design data and the printed circuit board manufacturing data which are stored in the data storage unit;
searches the current path in the manufactured printed circuit board based on the printed circuit board design data and the printed circuit board manufacturing data which are acquired;
determines a value of an electric current flowing in each copper foil plane, which forms wiring of the current path, with respect to the searched current path;
determines a copper foil plane current path indicative of the current path in each copper foil plane;
calculates the current density in each copper foil plane based on the value of the electric current and the copper foil plane current path which are determined with respect to each copper foil plane; and
judges whether the calculated current density exceeds the allowable range of the designed value or not, and determines a wiring part of the copper foil plane, which does not satisfy a criterion for the judgment, as the rejected part.

2. The printed circuit board design verification system according to claim 1, wherein the design verification unit: calculates a steady-state current density indicative of the current density of the copper foil plane in a case of a steady-state current being supplied to the printed circuit board, and an abnormal current density indicative of the current density of the copper foil plane in a case of an abnormal current being supplied to the printed circuit board; and judges whether each of the calculated steady-state current density and abnormal current density exceeds the allowable range of the designed value which is defined according to each current density.

3. The printed circuit board design verification system according to claim 1, wherein when searching the current path in the printed circuit board, the design verification unit determines a starting point component to which the electric current is supplied based on the number of pins for a plurality of components connected to wiring on the printed circuit board; and when reaching ground wiring and reaching a specified component with heavy power consumption during the process of searching the current path, whose starting point is the determined starting point component, the design verification unit will not search the current path any further.

4. The printed circuit board design verification system according to claim 1, wherein the design verification unit calculates the current density in the copper foil plane based on the value of the electric current flowing through the copper foil plane, a minimum value of a width of a copper foil surface relative to the copper foil plane current path in the copper foil plane, and a thickness of a copper foil layer of the copper foil plane.

5. The printed circuit board design verification system according to claim 1, wherein the design verification unit determines the copper foil plane current path in each copper foil plane according to positions of a starting point and an end point, to which the electric current is supplied to the copper foil plane, and a shape of the copper foil plane.

6. The printed circuit board design verification system according to claim 5, wherein when any component connected to wiring does not exist in the copper foil plane, the design verification unit treats a via provided and connected to the copper foil plane as the starting point or the end point of the copper foil plane current path.

7. The printed circuit board design verification system according to claim 1, wherein the printed circuit board manufacturing data includes: an input current value indicative of the value of the electric current supplied to the printed circuit board; ground wiring information indicative of ground wiring of the printed circuit board; a component current value indicative of the value of the electric current flowing through a component mounted on the printed circuit board; and a wiring current value indicative of the value of the electric current flowing through wiring of the printed circuit board.

8. A printed circuit board design verification method by a printed circuit board design verification system for verifying whether or not a current density in a current path of a printed circuit board, when manufactured, exceeds an allowable range defined as a designed value,
the printed circuit board design verification system including:
an input unit for inputting data;
a data storage unit for storing the data input by the input unit;
a design verification unit for verifying, based on the data stored in the data storage unit, the current density in the current path of the printed circuit board when manufactured; and
an output unit for outputting a verification result by the design verification unit;
the printed circuit board design verification method comprising:
a data input step executed by the input unit of inputting, into the data storage unit, printed circuit board design data indicative of data determined by no later than a mid-course stage or it subsequent stage of designing of a printed circuit board, and printed circuit board manufacturing data indicative of data required when manufacturing the printed circuit board;
a data storage step executed by the data storage unit of storing the printed circuit board design data and the printed circuit board manufacturing data which have been input;
a data acquisition step executed by the design verification unit of acquiring the stored data;
a current path search step executed by the design verification unit of searching the current path in the manufactured printed circuit board based on the acquired data;
a current value determination step executed by the design verification unit of determining a value of an electric current flowing in each copper foil plane, which forms wiring of the current path, with respect to the searched current path;
a copper foil plane current path determination step executed by the design verification unit of determining a copper foil plane current path indicative of the current path in each copper foil plane for which the value of the electric current has been determined;
a current density calculation step executed by the design verification unit of calculating the current density in each copper foil plane based on the value of the electric current determined in the current value determination step and the copper foil plane current path determined in the copper foil plane current path determination step;
a rejected part judgment step executed by the design verification unit of judging whether the calculated current density exceeds the allowable range of the designed value or not, and determining a wiring part of the copper foil plane, which does not satisfy a criterion for the judgment, as a rejected part; and
a verification result output step executed by the output unit of outputting the wiring part which has been determined as the rejected part in the rejected part judgment step.

9. The printed circuit board design verification method according to claim 8, wherein in the current density calculation step, the design verification unit calculates a steady-state current density indicative of the current density of the copper foil plane in a case of a steady-state current being supplied to the printed circuit board, and an abnormal current density indicative of the current density of the copper foil plane in a case of an abnormal current being supplied to the printed circuit board; and
in the rejected part judgment step, the design verification unit judges whether each of the steady-state current density and the abnormal current density which have been calculated in the current density calculation step exceeds the allowable range of the designed value which is defined according to each current density.

10. The printed circuit board design verification method according to claim 8, wherein in the current path search step, when searching the current path in the printed circuit board, the design verification unit determines a starting point component to which the electric current is supplied based on the number of pins for a plurality of components connected to wiring on the printed circuit board; and when reaching ground wiring and reaching a specified component with heavy power consumption during the process of searching the current path, whose starting point is the determined starting point component, the design verification unit will not search the current path any further.

11. The printed circuit board design verification method according to claim 8, wherein in the current density calculation step, the design verification unit calculates the current density in the copper foil plane based on the value of the electric current flowing through the copper foil plane, a minimum value of a width of a copper foil surface relative to the copper foil plane current path in the copper foil plane, and a thickness of a copper foil layer of the copper foil plane.

12. The printed circuit board design verification method according to claim 8, wherein in the copper foil plane current path determination step, the design verification unit determines the copper foil plane current path in each copper foil plane according to positions of a starting point and an end point, to which the electric current is supplied to the copper foil plane, and a shape of the copper foil plane.

13. The printed circuit board design verification method according to claim 12, wherein in the copper foil plane current path determination step, when any component connected to wiring does not exist in the copper foil plane, the design verification unit treats a via provided and connected to the copper foil plane as the starting point or the end point of the copper foil plane current path.

14. The printed circuit board design verification method according to claim 8, wherein in the data input step, the input unit inputs, into the data storage unit: the printed circuit board manufacturing data including an input current value indicative of the value of the electric current supplied to the printed circuit board, ground wiring information indicative of ground wiring of the printed circuit board, a component current value indicative of the value of the electric current flowing through a component mounted on the printed circuit board, and a wiring current value indicative of the value of the electric current flowing through wiring of the printed circuit board; and the printed circuit board design data.

15. A computer-readable recording medium with a program recorded therein for having a computer with a storage area, into which printed circuit board design data indicative of data determined by no later than a mid-course stage or its subsequent stage of designing of a printed circuit board, and printed circuit board manufacturing data indicative of data required when manufacturing the printed circuit board are input and stored, execute the following procedures:
a data acquisition procedure for acquiring the printed circuit board design data and the printed circuit board manufacturing data which are stored in the storage area;
a current path search procedure for searching a current path in the manufactured printed circuit board based on the data acquired in the data acquisition procedure;
a current value determination procedure for determining a value of an electric current flowing in each copper foil plane, which forms wiring of the current path, with respect to the current path searched in the current path search procedure;
a copper foil plane current path determination procedure for determining a copper foil plane current path indicative of the current path in each copper foil plane for which the value of the electric current was determined in the current value determination procedure;
a current density calculation procedure for calculating a current density in each copper foil plane based on the value of the electric current determined in the current value determination procedure and the copper foil plane current path determined in the copper foil plane current path determination procedure; and
a rejected part judgment procedure for judging whether the current density calculated in the current density calculation procedure exceeds an allowable range of a designed value or not, and determining a wiring part of the copper foil plane, which does not satisfy a criterion for the judgment, as a rejected part.
